(19) United States
(12) Patent Application Publication
(10) Pub. No.: US 2026/0093441 A1
(43) Pub. Date: Apr. 2, 2026

(54) SYSTEMS AND TECHNIQUES FOR AUDIO SYNCHRONIZATION ACROSS DEVICES

(71) Applicant: Epic Games, Inc., Cary, NC (US)

(72) Inventors: Paul deNyse Burrowes, IV, Woburn, MA (US); Ryan William Challinor, Cambridge, MA (US); Christopher Ritter, San Francisco, CA (US); Daniel William Chace, Salem, MA (US); Kevin Cavanaugh, Wilmington, MA (US); Matthew Booth, Uttoxeter (GB)

(73) Assignee: Epic Games, Inc., Cary, NC (US)

(21) Appl. No.: 18/904,690

(22) Filed: Oct. 2, 2024

(51) Int. Cl. G06F 3/16; A63F 13/54; A63F 13/63

(52) U.S. Cl. CPC G06F 3/165; A63F 13/54; A63F 13/63

(57) ABSTRACT

Systems and techniques for synchronizing audio across multiple devices are described herein. The techniques synchronize experience across devices generating respective audio signals of the sound piece, where each of the devices are configured to dynamically modify the sound piece responsive to respective user input. The devices receive synchronization data indicating an audio sequence of the sound piece and a target point in the audio sequence and render respective audio signals using the synchronization data. While rendering the audio signal, the devices receive updated synchronization data indicating an updated target point and a modification to the audio sequence. In response to receiving the updated synchronization data, the devices may render using the updated target point and modified audio sequence.

### BACKGROUND

Multiplayer videogames provide virtual environments that allow multiple users to interact with each other. A virtual environment may provide controls with which users can affect graphics or audio in the virtual environment. For example, the users may have virtual characters that they control in the virtual environment. The virtual characters may perform various actions in the virtual environment that can cause changes to the virtual environment. Additionally, or alternatively, users may directly control aspects of the virtual environment through inputs to the videogame.

### FIELD

This disclosure relates to techniques of synchronizing the experience of a sound piece across multiple devices that are simultaneously rendering audio signals of the sound piece and may make modifications to the sound piece.

### SUMMARY

Systems and techniques for synchronizing audio across multiple devices are described herein. The techniques synchronize a user experience of a sound piece across devices generating respective audio signals of the sound piece, where each of the devices are configured to dynamically modify the sound piece responsive to respective user input. The devices receive synchronization data indicating an audio sequence of the sound piece and a target point in the audio sequence and render respective audio signals using the synchronization data. While rendering the audio signal, the devices receive updated synchronization data indicating an updated target point and a modification to the audio sequence. In response to receiving the updated synchronization data, the devices may render using the updated target point and modified audio sequence.

According to one aspect, a method performed by a system for synchronizing a sound piece across a plurality of devices generating respective audio signals of the sound piece is provided. The method comprises using at least one computer processor of the system to perform: transmitting, to the plurality of devices, synchronization data indicating: an audio sequence of the sound piece for rendering, by the plurality of devices, the respective audio signals, and a target point in the audio sequence for the plurality of devices to use in synchronizing rendering of the respective audio signals, receiving, from a first device of the plurality of devices, a first input indicating a modification to the audio sequence of the sound piece, in response to receiving the first input, updating the synchronization data to generate updated synchronization data, the updated synchronization data indicating an updated target point in the audio sequence and the modification to the audio sequence, and transmitting, to one or more of the plurality of devices, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

According to one aspect, a system for synchronizing a sound piece across a plurality of devices generating respective audio signals of the sound piece is provided. The system comprises: at least one computer processor, and at least one non-transitory computer readable medium storing processor-executable instructions, that when executed by the at least one processor, cause the at least one processor to perform: transmitting, to the plurality of devices, synchronization data indicating: an audio sequence of the sound piece for rendering, by the plurality of devices, the respective audio signals, and a target point in the audio sequence for the plurality of devices to use in synchronizing rendering of the respective audio signals, receiving, from a first device of the plurality of devices, a first input indicating a modification to the audio sequence of the sound piece, in response to receiving the first input, updating the synchronization data to generate updated synchronization data, the updated synchronization data indicating an updated target point in the audio sequence and the modification to the audio sequence, transmitting, to one or more of the plurality of devices, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

According to one aspect, a non-transitory computer-readable medium storing processor-executable instructions, that when executed by at least one computer processor, causes the at least one computer processor to perform a method for synchronizing a sound piece across a plurality of devices generating respective audio signals of the sound piece, is provided. The method caused to be performed by the at least one computer processor comprising: transmitting, to a plurality of devices, synchronization data indicating: an audio sequence of a sound piece for rendering, by the plurality of devices, respective audio signals, and a target point in the audio sequence for the plurality of devices to use in synchronizing rendering of the respective audio signals, receiving, from a first device of the plurality of devices, a first input indicating a modification to the audio sequence of the sound piece, in response to receiving the first input, updating the synchronization data to generate updated synchronization data, the updated synchronization data indicating an updated target point in the audio sequence and the modification to the audio sequence, transmitting, to one or more of the plurality of devices separate from the first device, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

According to one aspect, a method for synchronizing a sound piece on a device with a plurality of devices generating respective audio signals of the sound piece, is provided. The method comprises: using at least one computer processor of the device to perform: receiving, from a synchronization system, synchronization data indicating an audio sequence of the sound piece and a target point in the audio sequence, rendering an audio signal using the synchronization data, while rendering the audio signal, receiving updated synchronization data indicating an updated target point and a modification to the audio sequence, the updated synchronization data received after input from another one of the plurality of devices was provided to the synchronization system, the input indicating the modification to the audio sequence, and in response to receiving the updated synchronization data, rendering the audio signal using the updated synchronization data at least in part by synchronizing the rendering based on the updated target point in the audio sequence.

According to one aspect, a device configured to synchronize a sound piece with a plurality of devices generating respective audio signals of the sound piece is provided. The device comprises: at least one computer processor, and at least one non-transitory computer readable medium storing processor-executable instructions, that when executed by the at least one computer processor, cause the at least one computer processor to perform: receiving, from a synchronization system, synchronization data indicating an audio sequence of the sound piece and a target point in the audio sequence, rendering an audio signal using the synchronization data, while rendering the audio signal, receiving updated synchronization data indicating an updated target point and a modification to the audio sequence, the updated synchronization received after input from another one of the plurality of devices provided to the synchronization system, the input indicating the modification to the audio sequence, and in response to receiving the updated synchronization data, rendering the audio signal using the updated synchronization data at least in part by synchronizing the rendering based on the updated target point in the audio sequence.

According to one aspect, a non-transitory computer-readable medium storing processor-executable instructions, that when executed by at least one computer processor, cause the at least one computer processor of a device to perform a method for synchronizing a sound piece on the device with a plurality of devices generating respective audio signals of the sound piece, is provided. The method caused to be performed by the at least one computer processor comprises: receiving, from a synchronization system, synchronization data indicating an audio sequence of a sound piece and a target point in the audio sequence, rendering an audio signal using the synchronization data, while rendering the audio signal, receiving updated synchronization data indicating an updated target point and a modification to the audio sequence, the updated synchronization received after input from another one of a plurality of devices provided to the synchronization system, the input indicating the modification to the audio sequence, and in response to receiving the updated synchronization data, rendering the audio signal using the updated synchronization data at least in part by synchronizing the rendering based on the updated target point in the audio sequence.

The foregoing summary is non-limiting.

### BRIEF DESCRIPTION OF THE DRAWINGS

FIG. 1 illustrates an example environment in which a synchronization system may be deployed, according to some embodiments of the technology described herein.

FIG. 2 illustrates an example data flow for generating synchronization data, according to some embodiments of the technology described herein.

FIG. 3 illustrates an example data flow for updating a local sound piece in response to user inputs, according to some embodiments of the technology described herein.

FIG. 4 illustrates an example process for updating a sound piece at a local device using synchronization data, according to some embodiments of the technology described herein.

FIG. 5 is a flowchart for an example process for synchronizing experience of a sound piece across multiple devices, according to some embodiments of the technology described herein.

FIG. 6 is a flow chart of a process for rendering an audio signal based on synchronization data, according to some embodiments of the technology described herein.

FIG. 7 is a flow chart of an example process for adjusting a speed of rendering of an audio signal using synchronization data, according to some embodiments of the technology described herein.

FIG. 8A is an example view of a virtual environment, according to some embodiments of the technology described herein.

FIG. 8B is an example display of a user interacting with a musical effect generator in the virtual environment of FIG. 8B, according to some embodiments of the technology described herein.

FIG. 9 is a block diagram of a computing device, according to some embodiments of the technology described herein.

### DETAILED DESCRIPTION

Described herein are techniques for synchronizing the experience of a sound piece across multiple devices while the devices are generating respective output audio signals of the sound piece and making modifications to the sound piece.

Multiple devices may interact with a central system (e.g., a server) to provide a virtual environment in which users of the devices can interact with each other. An important aspect of the virtual environment is synchronizing the audio of a sound piece in the virtual environment for users of the different devices. A sound piece that is to be rendered by the devices as part of the virtual environment ideally needs to be rendered so it is experienced similarly by all the users. The virtual environment may further provide users with the capability to modify the sound piece while it is being output by the devices. As an illustrative example, the virtual environment may be a multiplayer videogame in which users are interacting with each other. The videogame may be providing a sound piece (e.g., an audio file) that is to be output by each of the devices. The videogame include provide controls that the users can use to make changes to the sound piece (e.g., by adding notes, adding sound effects, changing a tempo, changing a speed of playback, and/or other changes). The central system needs to communicate updates to a sound piece made by one device to the other devices such that the other devices experience the updated sound piece.

However, synchronizing the experience of a sound piece across multiple different devices while they are rendering the sound piece is challenging. The speed and stability of the devices' connections to a central system may differ and change over time. Thus, the latency of communication between the central system and each device may change. The devices may receive messages sent by the central system at different times, causing the devices to react differently (e.g., such that different experiences are provided to the users of the devices). This challenge is further compounded in a virtual environment in which users can modify a sound piece while it is being rendered by the devices. The central system may frequently send messages to the devices indicating updates to a sound piece. The inconsistency and variability of connections between the central system and the devices may vary the experience of the sound piece and create undesirable effects. For example, a device can receive an update message at a later point in time than other devices, which can cause the device to apply an update at a later point in the sound piece relative to the other devices (e.g., by adding a sound effect to the sound piece at a later point in the sound piece than the other devices). As another example, a device that receives an update message later than other devices may be unable to apply the update to the sound piece (e.g., because the device has passed a point in the audio sequence at which to apply the update). As a further example, a device that receives update messages slower than other devices may end up far behind or ahead of other devices in the audio sequence (e.g., because the device is delayed in applying changes to tempo).

To address the above-described challenges in audio synchronization, the inventors have developed improved techniques for synchronizing the experience of a sound piece across multiple devices. The techniques reduce differences in experience of the sound piece across the devices. Specifically, the techniques allow users to hear modifications to the sound piece at similar points in the audio sequence despite differences in latency of communication with a central system. The techniques further allow devices to synchronize based on messages from a central system while mitigating undesirable audio effects such as skipping part of the sound piece and/or missing updates to the sound piece.

In embodiments of techniques described herein, a central system (referred to as a “synchronization system”) may periodically transmit synchronization data to devices that are generating output audio signals of a sound piece and can update the sound piece in real time. The synchronization system transmits an audio sequence of the sound piece that is to be rendered by the devices along with a target point in the audio sequence. The devices may be configured to synchronize audio output by using the audio sequence and the target point. For example, the devices may adjust a speed of rendering their respective audio signals using the target point in the audio sequence. This may allow the devices to gradually modify audio output based on the synchronization data without skipping or missing updates to a sound piece.

In response to receiving input from a device indicating a modification (e.g., an added note, a changed tempo, a sound effect, or other modification) to an audio sequence of a sound piece, the synchronization system may update the synchronization data it transmits to the devices. The synchronization system may transmit the updated audio sequence and an updated target point in the audio sequence. The devices may synchronize rendering of respective audio signals by rendering the updated audio sequence (which includes the modification) based on the updated target point in the audio sequence. The target point in the updated audio sequence allows the devices to experience the modification to the audio sequence at similar points in the audio sequence of the sound piece.

A sound piece may include any audio data that may be rendered into an output audio signal. For example, a sound piece may include one or more of: music, sound effects, audio effects, and dialogue. A sound piece may be indicated by an audio sequence. An audio sequence of a sound piece may include a stream of data (e.g., binary data) specifying the sound piece. For example, the audio sequence may be a stream of instructions that can be used to render an audio signal of the sound piece. As another example, the audio sequence may be a sequence of numerical data specifying notes of the sound piece. In some embodiments, the audio sequence of a sound piece includes Musical Instrument Digital Interface (MIDI) data for rendering the sound piece at a user device. In some embodiments, the audio sequence of a sound piece may have one or more audio effects applied, for example a distortion effect, a reverb effect, a delay effect, a chorus effect, a pan effect, a filter effect, a compression effect, a modulation effect, a vibrato effect, a bass effect, and a treble effect, among other audio effects. In some embodiments, an audio sequence may have a mode which controls the playing of the audio. For example, a mode of an audio sequence may be a MIDI mode. For example, a mode of an audio sequence may be one or more of OMNI, MONO/POLY, ALL NOTES OFF and/or LOCAL CONTROL. In some embodiments, an audio sequence may be in a specific musical key.

An audio sequence of a sound piece may be modified. An audio sequence may be modified by adding, removing, or changing the data of the audio sequence. For example, data may be added to or removed from an audio sequence representing musical notes to be played as the sound piece is rendered at a user device. An audio sequence may be modified by adding, removing or modifying an audio effect of the audio sequence. For example, a distortion effect may be added to or removed from an audio sequence, or a level of bass in the audio sequence may be raised or lowered. An audio sequence may be modified by changing a mode of the audio sequence. For example, the MIDI mode of a MIDI audio sequence may be changed. An audio sequence of a sound piece may be modified based on user inputs to user devices. For example, a user may interact with one or more elements of a multiplayer video game via a user device to modify an audio sequence.

Some embodiments provide a synchronization system for synchronizing experience of a sound piece across multiple devices while the devices are generating respective output audio signals of the sound piece. Each of the devices may be configured to dynamically modify the sound piece in response to user input (e.g., in a multiplayer videogame) during rendering of a respective output audio signal of the sound piece. The synchronization system transmits, to the devices, synchronization data. The synchronization data includes (1) an audio sequence of the sound piece for rendering by the devices into respective audio signals and (2) a target point in the audio sequence for the devices to use to synchronize rendering of the respective audio signals. In response to receive an input from one of the devices indicating an update to the sound piece, the system updates the synchronization data to obtain a modified audio sequence and an updated target point within the audio sequence. The synchronization system transmits the updated synchronization data to the devices which causes the devices to render their respective audio signals using the updated synchronization data. The transmission of the updated synchronization data causes the devices to render their respective audio signals based on the updated target point in the audio sequence.

Some embodiments provide techniques for a device to synchronize its experience of a sound piece that is being rendered by the device and one or more other devices. Each of the devices may be configured to dynamically modify the sound piece responsive to user input (e.g., in a multiplayer videogame). The device may receive communications from a synchronization system. The device may receive, from the synchronization system, synchronization data indicating an audio sequence of the sound piece and a target point in the audio sequence. The device may use the synchronization data to render its audio signal. The device may receive updated synchronization data while its rendering the audio signal when another one of the devices modifies the sound piece. The updates synchronization data may indicate a modified audio sequence and an updated target point in the audio sequence. In response to receiving the updated synchronization data, the device renders its audio signal by synchronizing using the updated synchronization data (e.g., by adjusting speed of rendering the audio signal based on the updated target point).

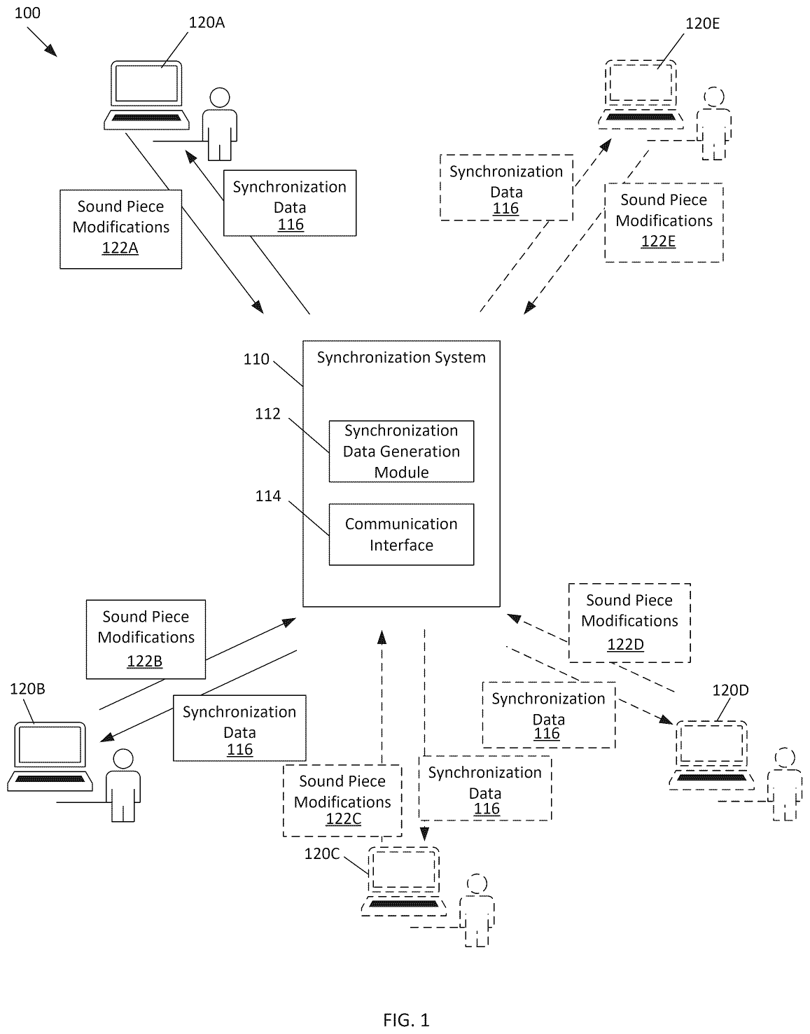

FIG. 1 illustrates an example environment in which a synchronization system 110 is deployed, according to some embodiments of the technology described herein. Environment 100 includes synchronization system 110 and user devices 120A-E. The user devices 120A-E may each be executing a software application that provides an interactive environment to a user of the device. Users of the devices 120A-E may interact with other users in the interactive environment. The users may work together in the interactive environment to modify a sound piece. The synchronization system 110 may synchronize the experience of the sound piece, including any modifications to the sound piece, across the devices 120A-120E. The synchronization system may be configured as a computing device (e.g., a server) which may receive data from and provide data to user devices. As an illustrative example, the user devices 120A-E may each be executing a multiplayer video game that allows users of the devices 120A-E to interact in a virtual environment of the video game. The users may interact in the virtual environment (e.g., by controlling virtual characters) to modify a sound piece in the video game.

In some embodiments, the user devices 120A-E may each be any suitable computing device. For example, each user device may be a desktop computer, a videogame console, a laptop computer, a smartphone, a tablet, a wearable device, or another computing device. In some embodiments, each of the user devices 120A-E may display a virtual environment (e.g., of a multiplayer videogame). For example, a user device may include a display for displaying the virtual environment. As another example, a user device may be an augmented reality (AR) or virtual reality (AR) device (e.g., AR or VR goggles) that provides a virtual environment. In some embodiments, each of the user devices 120A-E may include an audio output device. For example, a user device may include one or more speakers for outputting an audio signal of a sound piece. In some embodiments, each of the user devices 120A-E may include input hardware for interacting with the virtual environment. For example, each of the user devices 120A-E may include one or more of a handheld controller, a touch screen, motion sensors, a keyboard, a mouse and/or other input hardware for interacting with the virtual environment.

In some embodiments, the user devices 120A-E may each generate an output audio signal of a sound piece. The user devices 120A-E may generate respective audio signals of the sound piece by rendering the output signal (e.g., using an audio sequence specifying the sound piece). The user devices 120A-E may output generated audio signals through respective audio output devices (e.g., speakers). In some embodiments, a user device may execute a software application that renders an output signal an audio sequence. The software application may read the audio sequence and render it into an audio signal that is output by an audio output device (e.g., a speaker) of the user device. In some embodiments, a user device may modify rendering of the audio signal (e.g., based on synchronization data 116 received from the synchronization system 110). For example, the user device may configure a speed of rendering the audio signal (e.g., by increasing or decreasing a speed of rendering), rewind, seek to a particular point in an audio sequence, pause rendering, resume rendering, and/or modify rendering of the audio signal in another suitable way (e.g., using a software application).

In some embodiments, the user devices 120A-E may generate audio outputs based on synchronization data 116 received from the synchronization system 110. In some embodiments, the same synchronization data may be provided to each of the user devices 120A-E to synchronize the experience of a sound piece by users of the user devices 120A-E. In some embodiments, the synchronization data 116 may include an audio sequence for rendering audio outputs at the user devices 120A-E. The user devices 120A-E may render audio outputs based on the synchronization data by updating a local sound piece based on the synchronization data 116 and rendering the updated local sound piece. In some embodiments the synchronization data 116 may include a target point of an audio sequence for rendering audio outputs at the user devices 120A-E. A user device may synchronize rendering based on the target point. For example, the user device may increase or decrease a speed of rendering the audio sequence into an audio signal based on the target point.

In some embodiments, a user device may generate an audio signal using the synchronization data 116 by comparing a current timepoint of the local sound piece (e.g., in an audio sequence of the sound piece) that the device is rendering to a target point of the synchronization data 116. For example, a device may determine a difference between a current timepoint of the device in an audio sequence of the sound piece and a target point indicated by the synchronization data 116. In some embodiments, the device may update rendering of an audio signal of the sound piece based on results of the comparison between the local sound piece and the synchronization data 116. The device may modify the rendering based on the synchronization data 116. For example, the device may modify a speed of rendering the audio signal, seek to a particular point in an audio sequence of the sound piece, stopping rendering of the audio signal, or restarting rendering from a beginning of the sound piece.

In some embodiments, a user device may seek directly to a target point indicated by the synchronization data 116. When the user device determines that the difference is greater than a threshold difference, the user device may skip directly to the target point in the audio sequence of the sound piece. When it is determined that the difference is less than the threshold difference, the user device may increase or decrease a speed of rendering an audio signal until the timepoint is within a threshold of the target point of the synchronization data 116. In some embodiments, when a user device determines that there is a tempo difference between its local sound piece and a tempo indicated by the synchronization data, the user device may update its local tempo to match that of the local sound piece.

In some embodiments, a user device may generate an audio signal using the synchronization data 116 based on a frequency of updates received in the synchronization data 116. The device may determine whether to adjust its speed of rendering an audio signal based on the frequency of updates to a sound piece (e.g., to an audio sequence of the sound piece, or another update). When the device determines that there are too many updates to a sound piece received within a given time period, then the device may suspend modification to rendering. For example, if the device determines that an audio sequence has been updated within a time period after a previous update, the device may prevent modification of the rendering speed. For example, if the device determines that too many updates have been made to an audio sequence within a time period, the device may prevent modification of the rendering speed. This may provide a better audio experience for users and reduce perceived skipping or jumping due to a high frequence of sound piece modifications. In some embodiments, the device may prevent modifications to a sound piece for a time period between 0.5-60 seconds after a previous update. For example, the device may prevent modification to a sound piece for 2 seconds, 4 seconds, 8 seconds, 16 seconds, or another time period after modification. In some embodiments, the device increase a time period for preventing modifications to a sound piece after a sound piece is updated. For example, following a first update, the device may prevent modifications for a first time period, and, if additional modifications are received during the first time period or immediately after the first time period, the device may prevent modifications for a second time period, longer than the first time period, following updates due to the additional modifications.

In some embodiments, the device may increase the time period in which modifications are prevented incrementally following subsequent updates. In some embodiments, the time period in which modifications are prevented is increased for each successive update. For example, the time period in which modifications are prevented doubles following each successive update. In some embodiments, the time period in which modifications are prevented may be limited to a maximum value (e.g., 16 seconds, 32 seconds, or another time period). In some embodiments, the time period in which modifications are prevented decreases when updates are not made to the sound piece. For example, the time period may decrease linearly with local time of the device (e.g., from 16 seconds to 2 seconds).

In some embodiments, user inputs to the user devices 120A-E may include one or more modifications to the sound piece of the multiplayer video game. The user devices 120A-E may transmit these sound piece modifications 122A-E to the synchronization system 110 to synchronize the audio across all user devices 120A-E. In some embodiments, the sound piece modifications may be generated based on user inputs to the user devices 120A-E. In some embodiments, the user inputs may be provided via inputs to the user devices. For example, the user inputs may be provided through input hardware (e.g., a videogame controller, keyboard, mouse, touch screen, AR/VR interaction, and/or other input hardware). In some embodiments, the user inputs may include interacting with one or more elements of the virtual environment to generate the sound piece modifications. For example, users may place, connect to, change values of, provide inputs to or otherwise interact with elements in the virtual environment. In some embodiments, the user devices 120A-E may transmit data representative of user interactions with the virtual environment as sound piece modifications 122A-E.

In some embodiments, the sound piece modifications 122A-E may include data representing modifications to an audio sequence. In some embodiments, the sound piece modifications 122A-E may include an updated audio sequence with one or more user modifications. For example, the sound piece modifications 122A-E may include one or more of: an addition of one or more notes to an audio sequence of the sound piece; a removal of one or more notes from the audio sequence of the sound piece; an addition of one or more effects to the audio sequence of the sound piece; a removal of one or more effects from the audio sequence of the sound piece; a modification to one or more effects in the audio sequence of the sound piece; a modification to a key of the sound piece; a modification to a mode of the sound piece; a stoppage of rendering the sound piece into an audio signal; a resuming of rendering the sound piece into an audio signal; and/or restarting rendering of the sound piece from a beginning of the audio sequence. Example modifications mentioned herein to illustrate example embodiments. Some embodiments may employ other modifications in addition to or instead of those mentioned herein.

In some embodiments, the synchronization system 110 and user devices may be connected via a communication network. The communication network may be any suitable communication network. For example, the communication network may be the Internet, a cloud computing network, a local area network (LAN), or a wide area network (WAN), or another suitable communication network.

As illustrated in FIG. 1, the synchronization system 110 may receive sound piece modifications 122A-E from the user devices 120A-E. The synchronization system 110 may generate updated synchronization data 116 based on the sound piece modifications 122A-E for use by the user devices 120A-E in rendering synchronized audio of the sound piece. Thus, the synchronization system 110 synchronizes the experience of a sound piece across the user devices 120A-E as the synchronization system 110 receives sound piece modifications 120A-E. In some embodiments, the synchronization system 110 allows for the sound piece to be modified in real time by the user devices 120A-E through sound piece modifications 122A-E, while the user devices are rendering audio of the sound piece. The synchronization system 110 generates updated synchronization data 116 that reflects the real time sound piece modifications. The updated synchronization data 116 may then be used by the user devices 120A-D to generate audio signals of the updated sound piece (e.g., by using an updated audio sequence and/or modifying rendering of an audio sequence).

As illustrated in FIG. 1, the synchronization system 110 includes a synchronization data generation module 112 and a communication interface 114. The synchronization data generation module 112 may generate the synchronization data 116 that is transmitted to the user devices 120A-E. The synchronization data 116 may be transmitted to the user devices 120A-E through the communication interface 114.

The synchronization data 116 allows the user devices 120A-E to synchronize the experience of a sound piece across the user devices 120A-E (e.g., during gameplay of a videogame in which the sound piece is being dynamically synthesized). The synchronization data 116 may include various information that each of the user devices 120A-E is configured to use in generating an audio signal of a sound piece. In some embodiments, the synchronization data 116 may include an audio sequence of the sound piece (e.g., including the modifications 122A-E), a target point in the audio sequence, and/or a tempo for rendering the audio. The target point may be indicated by one or more parameters. For example, the target point may be indicated by a number of seconds into an audio sequence and/or a number of beats into the audio sequence. In some embodiments, the synchronization data 116 may include reference timepoints that may be used by the user devices 120A-E in rendering. For example, the reference timepoints may include a time when the synchronization system 110 transmitted the synchronization data 116. As another example, the reference timepoints may include a musical time signature.

The synchronization data generation module 112 may generate the synchronization data 116. In some embodiments, the synchronization data generation module 112 may generate the synchronization data 116 based on the sound piece modifications 122A-E. The synchronization data generation module 112 may analyze the sound piece modifications 122A-E to determine updates to the current synchronization data. In some embodiments, the synchronization data generation module 112 may analyze the sound piece modifications 122A-E by comparing the sound piece modifications 122A-E to current synchronization data to determine updates to be made to the synchronization data. For example, a sound piece modification may include a modified audio sequence of the sound piece, and the synchronization data generation module 112 may compare the audio sequence of the current synchronization to the modified audio sequence to determine an updated audio sequence to include in the synchronization data 116. To illustrate, the synchronization data generation module 112 may generate, based on a sound piece modification, an audio sequence with modifications relative to a previous audio sequence such as added/removed notes, modified tempo, changed mode, added/removed sound effects, and/or other modifications.

In some embodiments, the synchronization data generation module 112 may determine a target point to include in the synchronization data 116. The target point may be an indication of a point in the audio sequence of a sound piece for use in rendering an audio signal. For example, the target point may be indicated by an amount of time or a number of beats into the audio sequence for rendering. In some embodiments, the target point may be determined based on the passage of time. For example, the target point may be determined based on the time that has passed since the previous synchronization data (e.g., the target point may be increased based on an amount of time that has passed since a target point indicated by the previous synchronization data). In some embodiments, the target point may be determined based on sound piece modifications. For example, one or more of sound piece modifications 122A-E may indicate a target point for the sound piece, and/or an indication to restart, stop, or skip the sound piece.

Below is an example set of data that may specify a target point in the synchronization data. The example below is a C++ struct of various parameters that indicate a target point to use for synchronization.

```
struct FFabricTimelineSyncServerSongPosition
{
  FMusicTimestamp Timestamp;
  float SecondsIncludingCountIn = 0.0f;
  float Tempo = 0.0f;
  float BeatsIncludingCountIn = 0.0f;
  float NetServerTimeWhenSent = 0.0f;
  float TimeSigDenominator = 4.0f;
};
```

In the above example, the target point in the audio sequence is specified by a timestamp (“Timestamp”), a number of seconds into the audio sequence (“SecondsIncludingCountIn”), a tempo (“Tempo”), a number of beats into the audio sequence (“BeatsIncludingCountIn”), a time of the synchronization system 110 when the synchronization data 116 was sent (“NetServerTimeWhenSent”), and a musical time signature denominator (“TimeSigDenominator”). In the above example, the FMusicTimestamp data object may represent the current musical time in bars and beats. The data object may store a bar (e.g., as an integer value) and a beat (e.g., as floating point value). A device may compare its point in the audio sequence to the target point using the parameters. For example, the device may determine how many seconds and/or beats behind the device is in the audio sequence relative to the target point. The device may adjust the difference based on the time that the synchronization system 110 sent the synchronization data 116 (e.g., by removing the difference between the time and the device's local time).

The synchronization system 110 may receive sound piece modifications 122A-E and send synchronization data 116 via communication interface 114. Communication interface 114 may be any suitable interface for sending and receiving data over a computer network. In some embodiments, the communication interface includes a network interface card, modem or similar component for connecting to a network. In some embodiments, data (e.g., synchronization data and/or sound piece modifications) may be transmitted over the network as network packets such as TCP or IP format packets. In some embodiments, data may be transmitted between the user devices 120A-E and the synchronization system 110 via one or more application programming interfaces (APIs), which are associated with a software application (e.g., a multiple videogame) being executed by the user devices 120A-E.

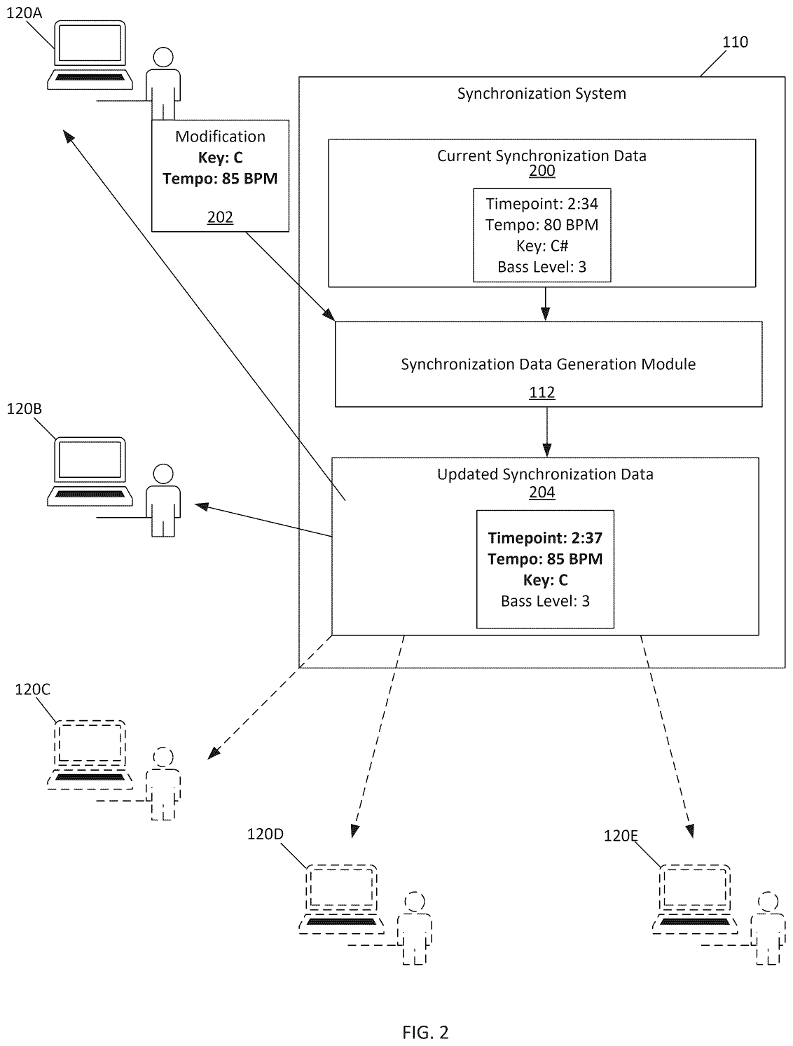

FIG. 2 illustrates an example data flow for generating synchronization data, according to some embodiments of the technology described herein. FIG. 2 includes synchronization system 110, and user devices 120A-E. FIG. 2 illustrates the process for generating updated synchronization data 204 based on sound piece modifications 202 received from user device 120A. In some embodiments, the data flow illustrated by FIG. 2 may be employed by the synchronization system 110 of FIG. 1 to generate synchronization data 116.

Synchronization system 110 includes current synchronization data 200. Current synchronization data includes a timepoint of 2:34 indicating the point in the sound piece that the user devices 120A-E should target rendering in an audio sequence of a sound piece. Current synchronization data 200 additionally includes a current tempo of the sound piece of 80 beats per minute (BPM), a musical key for the sound piece of C#, and a bass effect level in the sound piece of 3. The current synchronization data is shown by way of example only and, in some embodiments, may include data in addition to or instead of the data illustrated in the example embodiment of FIG. 2.

The synchronization system receives sound piece modifications 202 from user device 120A. As shown, the sound piece modifications 202 include a change in the key of the sound piece to the C key, and a change in tempo to 85 BPM at a future point in the audio sequence. In some embodiments, the sound piece modifications 202 may be input to user device 120A by a user of the device using one or more input hardware, as described herein. In some embodiments, the sound piece modifications 202 may be applied to the local sound piece being rendered at the user device 120A. The sound piece modifications may be transmitted over a computer network, as described herein. The sound piece modifications 202 are shown by way of example only and, in some embodiments, may include modifications in addition to or instead of those shown in the example embodiment of FIG. 2.

In some embodiments, the sound piece modifications 202 may be structured as one or more data structures (e.g., integer, float, list, array) which include data related to the sound piece modifications. In some embodiments, the sound piece modifications may include a representation of the local sound piece of the user device 120A (e.g., the audio sequence of the local sound piece). In some embodiments, the sound piece modifications 202 may only include data representative of changes to the local sound piece. In some embodiments, the sound piece modifications may include both the current representation of the local sound piece and data representative of changes to the local sound piece.

The sound piece modifications 202 are provided to the synchronization data generation module 112, along with the current synchronization data 200. The synchronization data generation module 112 may generate updated synchronization data 204 based on the current synchronization data 200 and sound piece modifications 202. In some embodiments, the synchronization data generation module 112 may compare the sound piece modifications 202 to the current synchronization data 200, to determine updates to be made to the synchronization data 200. The updates may be indicated in the updated synchronization data 204.

In some embodiments, the synchronization data generation module 112 may update the current synchronization data 200 using the sound piece modifications 202. As shown, the updated synchronization data 204 includes updated data shown in bold. The target point is updated from 2:34 to 2:37 indicating that the rendering should advance 3 seconds relative to the synchronization data 200. In some embodiments, the timepoint of the updated synchronization data is updated due to the passage of time since the current synchronization data was sent to the user devices. In some embodiments, the timepoint of the updated synchronization data is changed due to the sound piece modifications (e.g., due to changes in tempo, restarting, stopping and/or skipping). The tempo is updated to 85 BPM, to match that of the sound piece modifications 202. The key is updated to C, to match that of the sound piece modifications. The updated synchronization data 204 additionally includes the bass level of 3, which matches that of the current synchronization data 200 because the bass level has not been changed.

In some embodiments, the synchronization system 110 may not need to render an audio signal from an audio sequence because the synchronization system 110 does not need to output an audio signal to be heard by anyone. This eliminates processing time required for the synchronization system 110 to render audio that will not be heard. The synchronization system 110 may perform an intermediate rendering in which it renders audio sequence data without rendering an audio signal. In response to receiving the modification 202, the synchronization system 110 may render an updated audio sequence based on the indication of the update. For example, the change may indicate a modification to a note and the system may render a modified audio sequence including the modified note. In one implementation, the synchronization system 110 may render a set of MIDI notes into MIDI effects. The synchronization system 110 may receive modifications as updated MIDI notes which the synchronization system 110 may render into MIDI effects. The synchronization system 110 may generate updated synchronization data 204 based on its intermediate rendering.

In some embodiments, the synchronization system 110 may render an audio signal from an audio sequence. A modification to a sound piece may be based on the audio signal. Thus, the synchronization system 110 may render the audio signal to determine a modification to the audio sequence. For example, a device may trigger a modification to an audio sequence based on audio level (e.g., when the audio level crosses a threshold). The synchronization system 110 may render an audio signal from the audio sequence to determine whether to trigger the modification to the audio sequence based on the audio level (e.g., by determining whether the audio level of the rendered audio signal is above a threshold).

The updated synchronization data 204 may be provided to user devices 120A-E by the synchronization system 110, as described herein with reference to FIG. 1. In some embodiments, the synchronization system 110 may not provide the updated synchronization data 204 to the user device 120A which provided the sound piece modifications 202 used to generate the updated synchronization data 204. In some embodiments, the synchronization system 110 may provide the updated synchronization data 204 as one of set of period transmissions of synchronization data made by the synchronization system (e.g., as described herein with reference to FIG. 1).

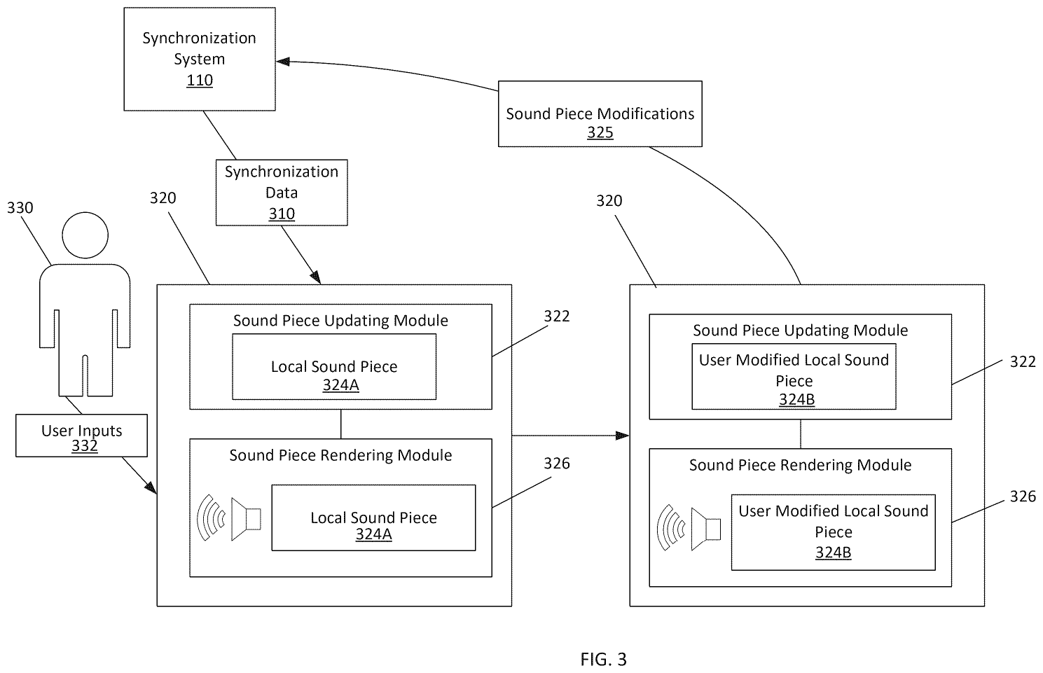

FIG. 3 illustrates an example data flow for updating a local sound piece due to user inputs, according to some embodiments of the technology described herein. FIG. 3 includes user device 320, operated by a user and connected to synchronization system 110. User device 320 may be a user device as described herein, for example, as described with reference to FIG. 1.

The user device 320 includes sound piece updating module 322 and sound piece rendering module 326. The sound piece updating module 322 may function to update the local sound piece 324A based on inputs to the user device 320, for example synchronization data 310 and/or user inputs 332. The local sound piece 324A may include data related to a sound piece including an audio sequence and timing data for use in rendering the sound piece (e.g., a timepoint, and/or tempo of the sound piece). The local sound piece 324A may be passed to sound piece rendering module 326. The sound piece rendering module 326 may render audio data from the local sound piece 324A. For example, the sound piece rendering module 326 may continuously generate an audio signal of local sound piece. In some embodiments, the audio signal may be output by the user device (e.g., by a speaker and/or other audio output) of the user device 320, such that the user may hear the sound piece.

The user 330 may provide user inputs 332 to modify one or more aspects of the sound piece. The user 330 provides user inputs 332 to the user device 320. In some embodiments, the user inputs 332 may be provided via one or more input hardware to the user device 320, as described herein. In some embodiments, the user inputs 332 may be provided as inputs to and/or interactions with one or more elements of a multiplayer video game. In some embodiments, the user inputs may include inputs to modify the timing of a sound piece (e.g., to speed up, slow down, stop, and/or restart a sound piece). In some embodiments, the user inputs may include one or modifications to an audio sequence of a sound piece. Example sound piece modifications are described herein.

As an illustrative example, the user device 320 may be executing a multiplayer interactive videogame in which the user 330 in participating. For example, the user 330 may be controlling a virtual character in a virtual environment of the videogame. The virtual environment may be one in which multiple users are collaborating to produce a sound piece while that sound piece is being rendered into an audio signal by the users' respective devices. Thus, the videogame may be a real-time audio production videogame. Other virtual character(s) associated with other user(s) may be in the virtual environment. The virtual environment may provide graphical elements that can be used by the user 330 to modify the local sound piece 324A. For example, the virtual environment may include a virtual audio synthesis station with various virtual controls with which the user 330 may modify the local sound piece 324A. The user 330 may interact with the graphical elements to update the local sound piece 324A. In some embodiments, the videogame may allow the user 330 to provide other forms of input, in addition to using the graphical elements, to modify the local sound piece 324A. For example, the videogame may allow the user to provide voice or motion input to modify the local sound piece 324A.

As shown, the updating module 322 applies user inputs 332 to the local sound piece 324A to generate the user modified local sound piece 324B. The user modified local sound piece 324B includes updates to the local sound piece 324A based on the user inputs 332. For example, the updates may include an update to an audio sequence of the sound piece. As another example, the updates may include one or more modifications to the timing of a sound piece (e.g., to speed up, slow down, stop, and/or restart a sound piece). Other example modifications are described herein. In some embodiments, the sound piece updating module 322 may analyze the user inputs 332 to determine one or more modifications to be made to the local sound piece 324A. The sound piece updating module 322 may then apply the determined updates to the local sound piece 324A, to generate user modified local sound piece 324B. The user modified local sound piece 324B may be passed to sound piece rendering module 326, which may render the user modified local sound piece 324B.

In some embodiments, the user device 320 may provide the sound piece modifications 325 to the synchronization system 110. The synchronization system 110 may analyze the sound piece modifications 325 to generate synchronization data, as described herein with reference to FIGS. 1-2. The synchronization data generated based on the sound piece modifications 325 may be provided to user devices other than user device 320, such that the other user devices may synchronize their audio to the modified local sound piece 324B. In this way, the synchronization system 110 allows for multiple user devices to have a unified audio experience.

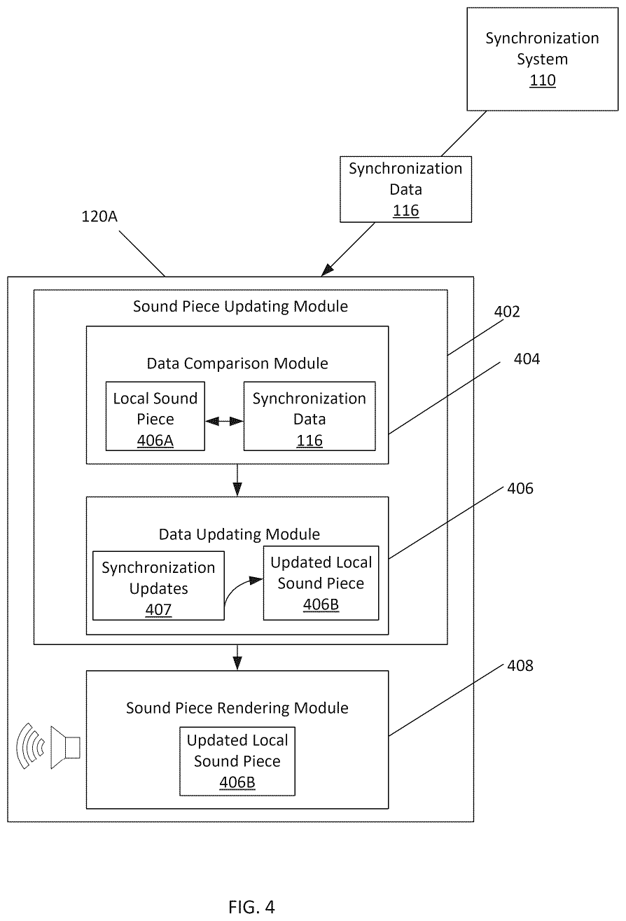

FIG. 4 illustrates an example process for updating a sound piece at a local device based on synchronization data, according to some embodiments of the technology described herein. FIG. 4 includes synchronization system 110, which provides synchronization data 116 to user device 120A. The synchronization data 116 may be generated by the synchronization system 110 in response to sound piece modifications received from a user device. In some embodiments the synchronization data 116 may be generated by the synchronization system 110 in response to sound piece modifications received from a user device, different from user device 120A. For example, the synchronization data 116 may be generated responsive to actions in a multiplayer video game being executed by user devices connected to the synchronization system 110.

As shown in FIG. 4, user device 120A includes sound piece updating module 402 and sound piece rendering module 408. The sound piece updating module 402 includes data comparison module 404 and data updating module 406.

The data comparison module 404 may compare the local sound piece 406A to the synchronization data 116 received from the synchronization system 110. In some embodiments, the comparison may involve comparing timing data of the local sound piece 406A to that of the synchronization data 116, and/or comparing an audio sequence of the local sound piece 406A to that of the synchronization data 116. Synchronization updates 407 may be determined by the data comparison module 404 based on the comparison of the local sound piece 406A to the synchronization data 116.

In some embodiments, comparing the timing data involves comparing a tempo of the local sound piece 406A to a tempo of the synchronization data 116. If the sound piece updating module 402 determines a difference between the tempos, the sound piece updating module 402 may update the tempo of the local sound piece to match that of the synchronization data 116. When there is a difference between the tempos, the synchronization updates 407 may include a tempo to which the local sound piece should be updated.

In some embodiments, comparing the timing data of the local sound piece 406A and the synchronization data 116 involves comparing a current timepoint of the local sound piece 406A (e.g., where the user device 120A is rendering) and a target point indicated by the synchronization data 116. In some embodiments, if there is a difference between the timepoint of the local time piece 406A and the target point indicated by the synchronization data, the sound piece updating module 402 may determine whether the difference is greater than a threshold difference. The threshold difference may be any suitable time difference. For example, the threshold difference may be: 2 seconds, 1 second, .75 seconds, .5 seconds, .25 seconds, 0.1 seconds, or any suitable time difference between 0.1 seconds and 2 seconds. In some embodiments, when the time difference is greater than the threshold time difference, the synchronization updates 407 may include a timepoint (e.g., the target point of the synchronization data) in the audio sequence of the local sound piece to skip to during rendering. For example, if the difference is greater than or equal to a threshold difference of 1 second, the device may seek to the timepoint. In some embodiments, when the time difference is less than the threshold difference (e.g., less than 1 second), the synchronization updates 407 may include an updated playback speed and a timepoint for rendering the local sound piece 406A.

In some embodiments, the sound piece updating module 402 may determine whether the difference between the timepoint of the local time piece 406A is greater than a threshold difference. For example, the threshold difference may be a value between 0.01 seconds and 1 second. If it is determined that the time difference is greater than the threshold difference, the synchronization updates 407 may include an updated playback speed (i.e., to reduce the difference). Otherwise, the sound piece updating module 402 may not modify a playback speed.

In some embodiments, the playback speed is reduced based on a target point included in the synchronization updates 407. The sound piece updating module 402 may determine a difference between the target point in the synchronization updates 407 and a current point of the local sound piece 406A. When the sound piece updating module 402 determines that the current point of the local sound piece 406A is ahead of the target point by a threshold amount of time, the sound piece updating module 402 may reduce the playback speed. The threshold amount of time may be any suitable time between 0.01 and 2 seconds. For example, the threshold amount of time may be 0.1 seconds. To illustrate, when the sound piece updating module 402 determines that the current point of the local sound piece 406A is ahead of the target point by greater than 0.1 seconds, the sound piece updating module 402 may trigger a reduction in playback speed.

The timepoint included in the synchronization updates 407 may indicate the timepoint at which the local sound piece 406A is synchronized with the synchronization data 116. In some embodiments, the playback speed changed (e.g., increased or decreased) at the timepoint included in the synchronization updates 407 to match the timing of the synchronization data after the playback speed was increased or decreased based on the timing difference between the local sound piece and the synchronization data.

In some embodiments, comparing the local sound piece 406A to the synchronization data 116 involves comparing the audio sequence of the local sound piece 406A to the audio sequence of the synchronization data 116. In some embodiments, when differences are determined between the audio sequence of the local sound piece 406A and the synchronization data 116 the sound piece updating module 402 may update an audio sequence of the local sound piece 406A such that it matches the audio sequence indicated by the synchronization data 116. Thus, the synchronization updates 407 include modifications to the audio sequence. In some embodiments, when there are no difference between the audio sequence of the local sound piece 406A and the synchronization data 116, the synchronization updates 407 do not include the audio sequence of the synchronization data.

Synchronization updates 407 are generated based on the synchronization data 116. In some embodiments, the synchronization updates 407 include one or more updates to the timing data of the local sound piece (e.g., the tempo, speed and/or a timepoint of the sound piece). In some embodiments, the synchronization updates 407 include one or more updates to the audio sequence of the local sound piece. In some embodiments, the synchronization updates 407 are generated by the data comparison module 404. In some embodiments, the synchronization updates 407 are generated directly based on the synchronization data 116, for example when the synchronization data 116 indicates the sound piece should be stopped, data of the synchronization updates 407 may be generated indicating the sound piece should be stopped.

The data updating module 406 generates the updated local sound piece 406B, based on the synchronization updates 407. In some embodiments, the data updating module 406 updates the data of the local sound piece 406A based on the synchronization updates 407. For example, the data updating module may change the timing data of the local sound piece 406A, and/or the audio sequence of the local sound piece based on the updates included in synchronization updates.

The updated local sound piece 406B may then be provided to sound piece rendering module 408. The sound piece rendering module 408 may render the updated local sound piece 406B, for example by generating an audio signal based on the data of the updated local sound piece 406B. In some embodiments, the sound piece rendering module 408 may play the updated local sound piece 406B, for example on a speaker and/or other audio output of the user device 120A.

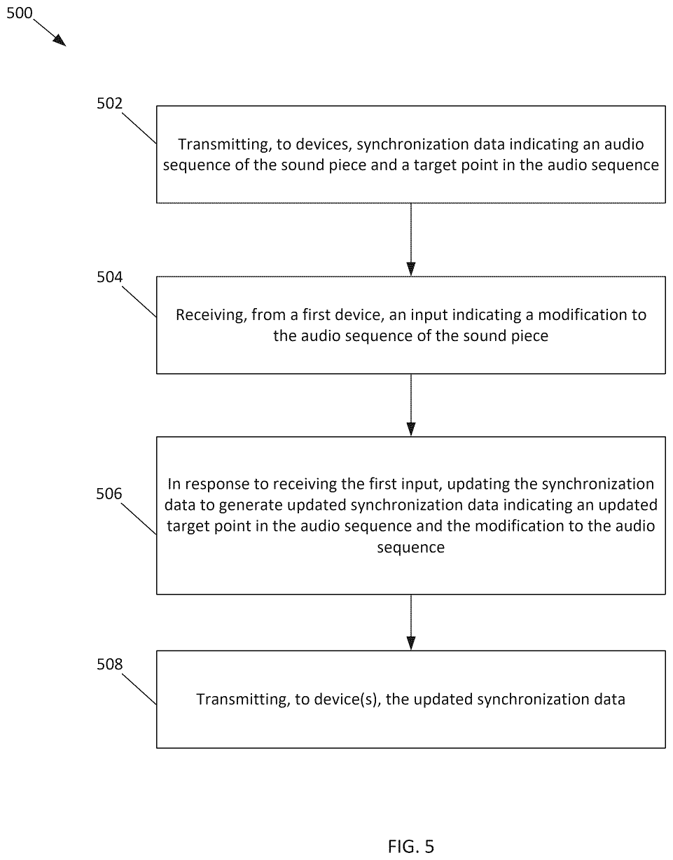

FIG. 5 includes a flowchart for an example process 500 for synchronizing experience of a sound piece across multiple devices, according to some embodiments of the technology described herein. The devices may be rendering audio signals of the sound piece and be configured to modify the sound piece during the rendering. For example, the devices may be executing an application (e.g., a video game application) that provides a virtual environment in which users can provide input to modify the sound piece as it is being rendered into an audio signal. In some embodiments, the process 500 may be performed by synchronization system 110 described herein with reference to FIG. 1.

Process 500 begins at step 501, where the system transmits, to the user devices, synchronization data indicating an audio sequence of the sound piece and a target point in the audio sequence. In some embodiments, the devices may include user devices, as described herein, such as user devices 120A-E as described with reference to FIG. 1. In some embodiments, the synchronization data may be transmitted in conjunction with a multiplayer videogame being played on the devices. The synchronization data transmitted to the devices may include timing data (e.g., a tempo and/or a timepoint) and/or an audio sequence, as described in herein. Example synchronization data is described herein with reference to FIG. 1. The synchronization data may be used by the devices in rendering local sound pieces, such as described herein with reference to FIG. 4, to provide a unified audio experience to users.

Next, in step 504 the system receives, from a first device, an input indicating a modification to the audio sequence of the sound piece. In some embodiments, the input may be provided by a user of the first device using input hardware of the first device, as described herein. In some embodiments, the input may be provided as a part of a multiplayer video game being played on the first device, for example by interacting with and/or providing inputs to one or more elements of the multiplayer video game. For example, the input may indicate a change to an audio sequence (e.g., a change to a note).

In some embodiments, the system may not need to render an audio signal from an audio sequence because the server does not need to output an audio signal to be heard by anyone. This eliminates processing time required for the server to render audio that will not be heard. The system may perform an intermediate rendering in which it renders audio sequence data without rendering an audio signal. In response to receiving the input indicating the change to the audio sequence, the system may render an updated audio sequence based on the indication of the update. For example, the change may indicate a modification to a note and the system may render a modified audio sequence including the modified note.

Next, in step 506 the system, in response to receiving the first input, updates the synchronization data to generate updated synchronization data indicating an updated target point in the audio sequence and the modification to the audio sequence. In some embodiments, the system updates the synchronization data, as described herein, for example as described with reference to FIG. 2. In some embodiments the first input is compared to the synchronization data, to determine updates to be made to the synchronization data. The updates may be used to generate the updated synchronization data. In some embodiments, the first inputs may be used directly as the updated synchronization data (e.g., by updating the audio sequence of the synchronization data using the modification of the first input). In some embodiments, the updated target point is determined based on the modification to the audio sequence. In some embodiments, the updated target point is determined based on the amount of time that has passed since the synchronization data was transmitted to the devices, in step 502.

Next, in step 508, the system transmits, to device(s), the updated synchronization data. In some embodiments, the updated synchronization data is transmitted to all devices of the devices. In some embodiments, the updated synchronization data is transmitted to devices, not including the first device. In some embodiments, the devices may utilize the updated synchronization data in rendering a local sound piece, as described herein, such as described with reference to FIG. 4. In some embodiments, the devices may perform a comparison of the local sound piece to the synchronization data and determine updates to be made to the local sound piece based on the comparison. The updated synchronization data allows the devices to have a unified audio experience, with updates being made in real-time or near real-time by users of the devices.

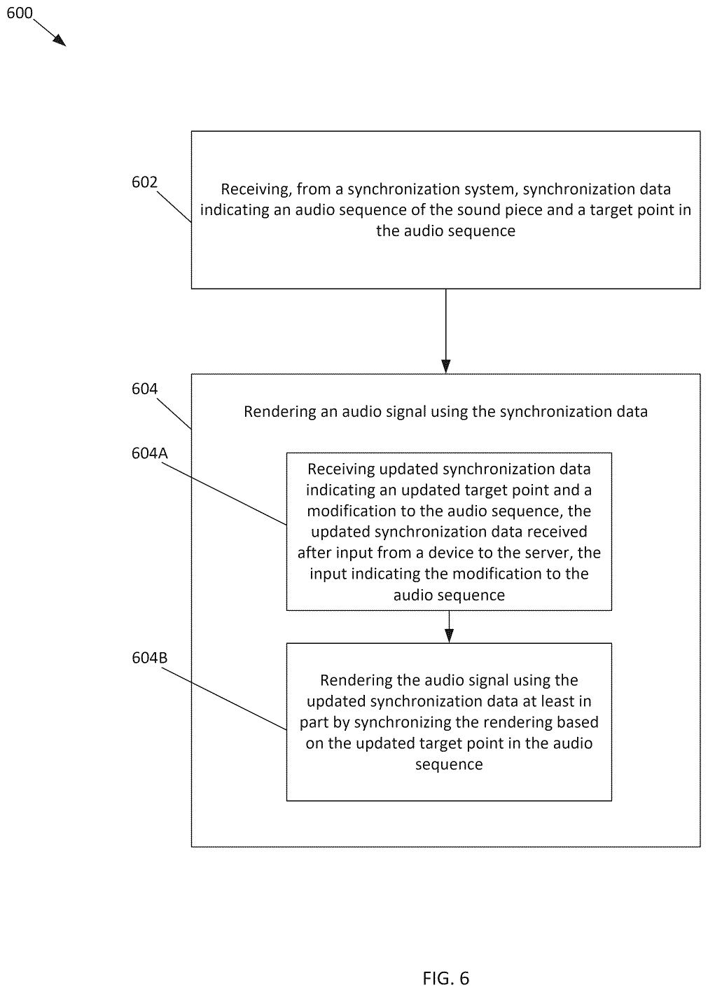

FIG. 6 includes a flow chart of a process for updating rendering of an audio signal based on synchronization data, according to some embodiments of the technology described herein. Process 600 may be performed by a user device, as described herein, for example devices 120A-E, and/or 320 as described herein. In some embodiments, process 600 may be performed for rendering audio associated with a multiplayer video game. In some embodiments, the process 600 is performed by one of multiple devices which are generating respective audio signals of a sound piece, where each of the devices is configured to dynamically modify the sound piece responsive to respective user inputs.

Process 600 begins at step 602, where the device receives, from a synchronization system (e.g., implemented on a server), synchronization data indicating an audio sequence of the sound piece and a target point in the audio sequence. In some embodiments, the synchronization data is generated in response to receiving sound piece modifications from one or more devices connected to the server, for example as described with reference to FIGS. 2 and 5. In some embodiments, the server may continuously transmit synchronization data for use in rendering audio.

Next, in step 604, the device renders an audio signal using the synchronization data. Step 604 includes sub step 604A, in which the device receives updated synchronization data indicating an updated target point and a modification to the audio sequence, the updated synchronization data received after input from a device to the server, the input indicating the modification to the audio sequence. In some embodiments, the input is provided by a user device, other than the device, in response to a user input, such as described herein with reference to FIG. 3. In some embodiments, the server generates the updated synchronization data based on the input. In some embodiments, the server generates the updated synchronization data as described herein, for example as described with reference to FIGS. 2 and 5.

Next, in sub step 604B the device renders the audio signal using the updated synchronization data, at least in part by synchronizing the rendering based on the updated target point in the audio sequence. In some embodiments, rendering the audio signal involves updating a local sound piece based on the updated synchronization data. In some embodiments, the synchronization data is compared to the local sound piece and updates are determined based on the comparison. The updates may be applied to the local sound piece and used in rendering the audio signal. In some embodiments, the local sound piece may be updated as described herein, for example, as described with reference to FIG. 4. In some embodiments, synchronizing the rendering involves changing a speed based on the updated target point of the updated synchronization data. In some embodiments, the speed is changed as described herein, for example with reference to FIG. 4.

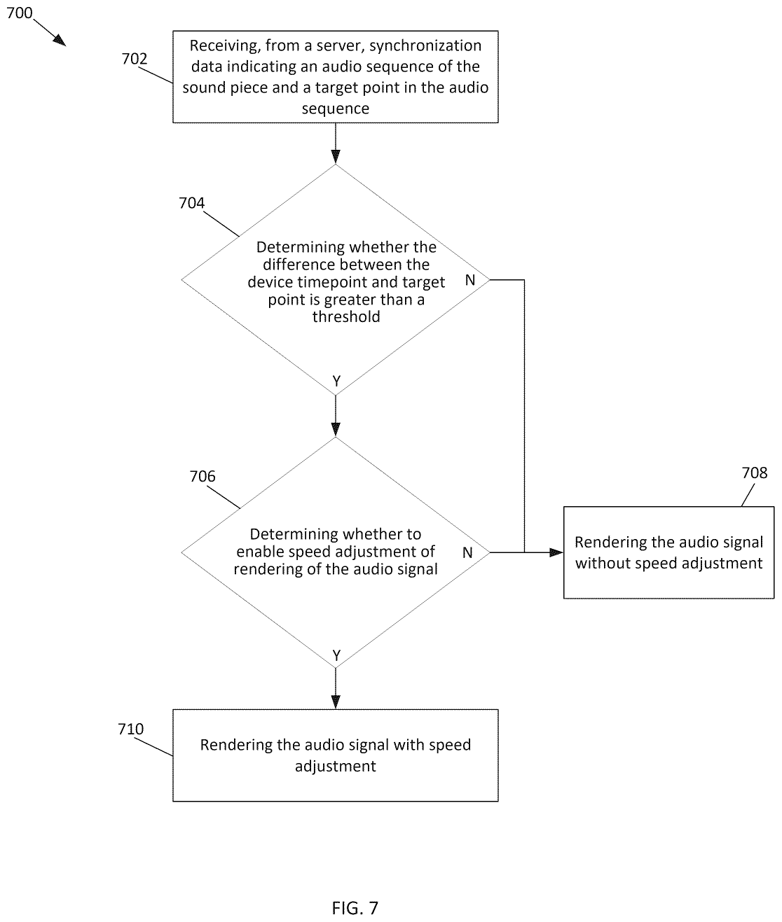

FIG. 7 is a flow chart of an example process for determining whether the speed of rendering of an audio signal is adjusted, according to some embodiments of the technology described herein. The process 700 of FIG. 7 may be performed by a user device and/or in conjunction with a process, as described herein, for example user devices 120A-E, and/or 320, and/or process 600.

Process 700 begins at step 702, where the device receives, from a server, synchronization data indicating an audio sequence of the sound piece and a target point in the audio sequence. In some embodiments, the synchronization data is generated in response to receiving sound piece modifications from one or more devices connected to the server, for example as described with reference to FIGS. 2 and 5. In some embodiments, the server may continuously transmit synchronization data for use in rendering audio. In some embodiments, the server may be configured to implement a synchronization system as described herein, such as system 110 of FIG. 1.

Next, in step 704 the device determines whether difference between the device timepoint and target point is greater than a threshold. The device may compare its timepoint in the audio sequence to the target point to determine the difference. The device may then compare the determined difference to the threshold difference. The threshold difference may be any suitable time difference for example, 2 seconds, 1 second, .75 seconds, .5 seconds, .25 seconds, .125 seconds, .0625 seconds, less than .0625, or any suitable time difference between .0625 seconds and 1 second.

If it is determined that the difference between the device timepoint and the target point is less than the threshold difference, step 708 is performed, in which the device renders an audio signal without speed adjustment. In some cases, the device may render the audio signal with one or more adjustments (e.g., to the audio sequence made by other device(s)), unrelated to the speed of rendering, for example with modifications to an audio sequence used in rendering the audio signal. In other cases, the device may render the audio signal without any adjustments.

If it is determined that the difference is greater than the threshold difference, step 706 is performed, in which the device determines whether to enable speed adjustment of rendering of the audio signal. In some embodiments, the device may determine whether to enable speed adjustment based on a frequency of modifications to the audio sequence. If the device determines that an update to the audio sequence has been received within a threshold amount of time of a previous update to the audio sequence, the device may disable speed adjustment. This is to prevent the rendering from rapidly changing due to multiple user inputs by the user of the device or users of other devices connected to the server. Such rapid changes would worsen the audio experience for the user. For example, if the device determines that a tempo has been modified within the threshold amount of time of a previous modification of the tempo, the device may disable speed adjustment. If the device determines that the update to the audio sequence has not been received within the threshold amount of time of the previous update to the audio sequence, the device may enable speed adjustment.

If it is determined that the speed adjustment is not enabled, the process proceeds to step 708, where the device renders the audio signal without the speed adjustment. If it is determined that the speed adjustment is enabled, the process 700 proceeds to step 710, in which the device renders the audio signal with speed adjustment. The speed adjustment may be to synchronize the rendering to the synchronization data. In some embodiments the speed adjustment synchronizes the rendering such that the device timepoint moves closer to the target point. In some embodiments, the speed adjustment is performed as described herein, for example as described with reference to FIG. 4.

By only enabling adjustment of the speed of the rendering to when the synchronization data is not rapidly changing, the device may eliminate undesired audio effects (e.g., skipping, improper updates to the audio sequence, and/or other undesired audio effects). Further, the difference between the timepoints is not increased due to multiple timing-related changes being applied simultaneously, which can lead to further rapid or abrupt changes to the rendering. This provides an improved audio experience to users, who may receive audio that is synchronized to that of other users in real time or near real time, with reduced skipping and/or jumping of the audio.

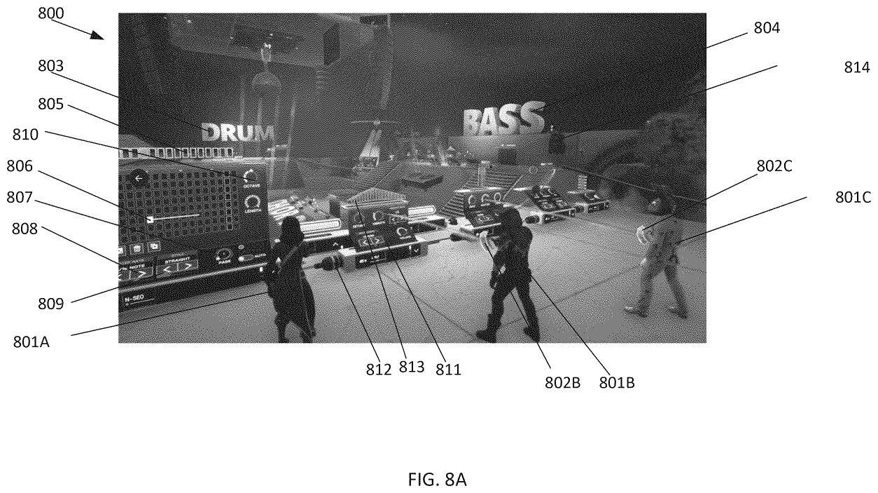

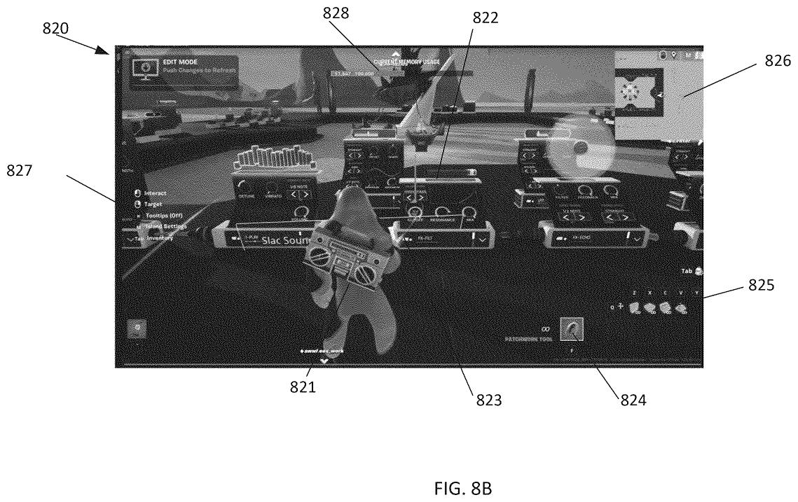

FIG. 8A is an example view of a virtual environment, according to some embodiments of the technology described herein. In some embodiments the virtual environment 800 is provided as a part of a multiplayer video game. In some embodiments the virtual environment 800 may be displayed on a display of a user device. In some embodiments, the virtual environment 800 may be an environment for users to collaborate in creating a sound piece, such as music or audio for a video game. In some embodiments, the virtual environment may have associated audio, which is synchronized across the user devices of the users participating in the virtual environment, for example, as described herein with reference to FIGS. 1-7.

As shown, the virtual environment includes three avatars, 801A-C, associated with respective users of the virtual environment. The avatars 801B and 801C are holding respective in-game tools 802B-C which allow the users to interact with the elements of the virtual environment.

The users may work together within environment 800 to compose a musical piece. In some embodiments, the users may generate an audio sequence of the musical piece using the elements of the environment 800.

As shown the virtual environment includes multiple elements for creating a musical piece. The environment 800 includes sections dedicated to different aspects of a musical piece, including a drums section 803 and a bass section 804. The users may control their respective avatars within the drums section 803 to adjust the drums of the musical piece, for example by adding drum sounds to an audio sequence. Similarly, the users may control their respective avatars within the bass section to adjust the bass of a musical piece, for example by adding a bassline to the audio sequence.

In some embodiments, users may add audio (e.g., musical notes, vocals, etc.) to the audio sequence of a musical piece by manually recording parts of the audio sequence, for example by providing inputs to the virtual environment corresponding to different drums, while the environment is recording, and adding the inputs to the audio sequence. In some embodiments users may add to the audio sequence of a musical piece by selecting prerecorded parts of the audio sequence, for example a user may select a prerecorded baseline for use in the audio sequence.

In some embodiments, the users may add effects to an audio sequence using one or more elements of the environment. As shown, the elements of environment 800 are represented as structures which the avatars 802A-C may interact with. These structures may be connected to each other via virtual connections which represent the addition of effects associated with these structures to an audio sequence.

In FIG. 8A, the avatars 802A-C are interacting with a series of elements of the environment 800. The elements the users are interacting with may be associated with a specific instrument in a sound piece or vocals. On the left side of FIG. 8A is Virtual music input 805. Users may interact with virtual music and put 805 to add audio to an audio sequence. Virtual music input 805 includes a display of boxes corresponding to timepoints of the audio sequence. In addition, on the display of virtual music input 805 is visual indicator 806 which corresponds to audio that has been added to the audio sequence over a series of timepoints. Virtual music input 805 includes multiple features which allow a user to interact with and adjust the audio added to an audio sequence. For example, page adjuster 807 allows a user to scroll through and select which page of the audio sequence is displayed on the display of the virtual music input 805. In addition, note adjustment 808 allows a user to adjust the length of a note which is added to the audio sequence buy virtual music input 805. Further, style adjustment 809 allows a user to select one or more styles of audio which is added to the audio sequence by virtual music input 805. In some embodiments, styles may be provided as a part of environment 800 and may change one or more aspects of audio added to the audio sequence, for example the musical key the audio is in. Virtual music input 805 additionally includes octave adjustment 810, which allows a user to select which active of the musical scale the audio added by virtual music input 805 is in.

The virtual music input 805 is connected to virtual musical effect generator 811 via virtual connection 812. The virtual musical effect generator 811 applies one or more musical effects to the audio sequence generated by the virtual music input 805. As shown the virtual musical effect generator 811 includes multiple inputs for changing the effects applied to the audio. The effects applied to the audio may be effects to change one or more aspects of the audio. Examples of audio effects that may be applied by a musical effect generator include a distortion effect, a reverb effect, a delay effect, a chorus effect, a pan effect, a filter effect, a compression effect, a modulation effect, a vibrato effect, a bass effect, and a treble effect, among other audio effects. Musical effect generator 811 additionally includes visual indicator 813, which indicates whether the musical effect generator 811 is active, and a level of the effect applied to the audio sequence. As shown, the musical effect generator 811 is connected to other musical effect generators which may apply additional effects to the audio sequence.

Virtual environment 800 additionally includes virtual speakers 814. The virtual speakers 814 are distributed throughout the virtual environment 800 and may virtually play in audio sequence generated by the users in the virtual environment 800. For example, as users move closer to the virtual speakers 814, the audio rendered by their respective devices may become louder, or may appear to change directions, as if the users are actually getting closer to the speakers.

FIG. 8B is an example display of a user interacting with a musical effect generator, according to some embodiments of the technology described herein. Virtual environment 820 is a virtual environment such as 800, as described with reference to FIG. 8A. Virtual environment 820 May be displayed to a user on a display of a user device.

As shown avatar 821 is interacting with a musical effect generator 822 using their virtual tool 823. As shown, the musical effect generator 822 is for a filter effect. The user has selected the filter effect to be a high pass filter and is currently using their virtual tool to adjust the cutoff frequency of the high pass filter. The user may control their avatar based on the indication of the virtual tool to select different inputs and/or settings of the musical effect generator 822.

Also shown in FIG. 8B are in-game displays. The in-game displays may provide information to the user of the device displaying virtual environment 820 information about the game. For example, the in-game displays include virtual tool selection 824, which indicates to the user the virtual tool currently selected for use by their avatar. The user may select from one or more tools for their avatar to use in the virtual environment 820. In addition, The end game displays include game element inventory 825. Game element inventory 825 provides a display of one or more in-game elements Available for a user to place. For example, a user may place elements corresponding to virtual musical inputs, musical effect generators, virtual connections, in-game structure elements, among other elements which may be used in virtual environment 820. The in-game displays additionally include environment map 826, which indicates a position of the avatar 821 within virtual environment 820. The in-game displays additionally include in-game tips 827, which provide tips to the user on how to control their avatar. As shown, the in-game tips 827 provide indications to a user on how to use a computer mouse to control their avatar. In some environments, the in-game tips may include tips on how to control the avatar using different input hardware, for example a video game controller, touchpad, or other input hardware as described herein.

The in-game displays additionally include memory usage indication 828. In some embodiments, virtual environment 820 may limit a user on how many in-game elements may be used for generating a sound piece. The elements may be limited to ensure that a sound piece may be synchronized across the devices of all users interacting within virtual environment 820. The memory usage indication 828 provides an indication of how much computer memory is currently allocated to the in-game elements associated with generating the sound piece.

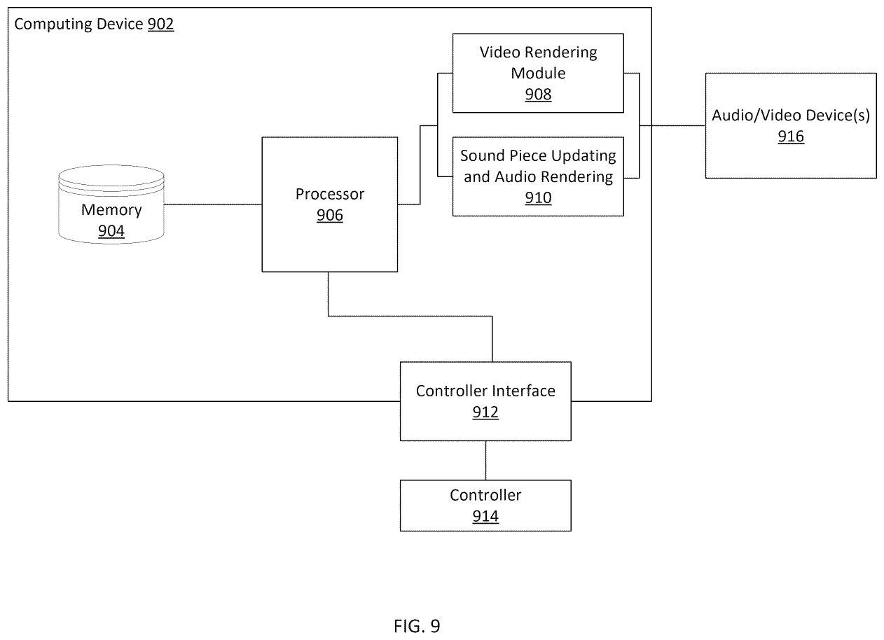

FIG. 9 is a block diagram of a computing device, according to some embodiments of the technology described herein. In some embodiments, the computing device 902 is a user device, as described herein. In some embodiments, the computing device 902 can be a dedicated game console, e.g., PLAYSTATION®3, PLAYSTATION®4, PLAYSTATION®5, or PLAYSTATION® VITA manufactured by Sony Computer Entertainment, Inc.; WII™, WII U™, NINTENDO 2DS™, or NINTENDO 3DS™, NINTENDO SWITCH™, or NINTENDO SWITCH™ LITE manufactured by Nintendo Co., Ltd.; or XBOX®, XBOX 360®, or XBOX ONE®, XBOX® SERIES X, or XBOX® SERIES S manufactured by Microsoft Corp. In some embodiments, the computing device 902 can be a computer configured to run a game platform and/or a virtual reality (VR) platform, such as those provided by PLAYSTATION®, XBOX®, Oculus, HTC, Sony, Apple, and/or the like. Examples of VR platforms include platforms with one or more spatially tracked controllers that are configured to work with a VR headset, such as the Oculus Rift, Oculus Quest, Oculus Quest 2, HTC Vive, Sony PLAYSTATION® PlayStation VR, Apple Vision Pro and/or the like. In other embodiments, the computing device 902 can be a general purpose desktop or laptop computer. In other embodiments, the computing device 902 can be a server connected to a computer network. In other embodiments, the computing device 902 can be user equipment. The user equipment can communicate with one or more radio access networks and with wired communication networks. The user equipment can be a cellular phone. The user equipment can also be a smartphone providing services such as word processing, web browsing, gaming, e-user equipment can also be a tablet computer providing network access and most of the services provided by a smart-phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The computing device 902 can include a memory device 904, a processor 906, a video rendering module 908, a sound piece updating and audio rendering module 910, and a controller interface 912. The controller interface 912 can couple the computing device 902 with a controller 914; the video rendering module 908 and the sound piece updating and audio rendering module 910 can connect to one or more audio/video devices 916. The sound piece updating and audio rendering module 910 may include modules for updating a sound piece and rendering audio, as described herein, for example as described with reference to FIGS. 3-4.

The non-transitory memory 904 can maintain data for running a multiplayer video game. The data for running the multiplayer video game may include data for rendering a virtual environment associated with the game and data for rendering audio associated with the game. The memory 904 can also maintain machine-readable instructions for execution on the processor 906.

In some embodiments, the memory 904 can take the form of volatile memory, such as Random Access Memory (RAM) or cache memory. In other embodiments, the memory 104 can take the form of non-volatile memory, including by way of example semiconductor memory devices, e.g., EPROM, EEPROM, and flash memory devices; or magnetic disks, e.g., internal hard disks or removable disks. In some embodiments, the memory 904 can include portable data storage devices, including, for example, magneto-optical disks, and CD-ROM and DVD-ROM disks.

The processor 906 can take the form of a programmable microprocessor executing machine-readable instructions, such as a computer processing unit (CPU). Alternatively, the processor 906 can be implemented at least in part by special purpose logic circuitry, e.g., an FPGA (field programmable gate array) or an ASIC (application-specific integrated circuit) or other specialized circuit. The processor 906 can include a plurality of processing units, each of which may independently operate on an input data, such as a gradient vector. In some cases, the plurality of processing units may be configured to perform an identical operation on different data. For example, the plurality of processing units can be configured in a single-instruction-multiple-data (SIMD) architecture to operate on multiple data using a single instruction. In other cases, the plurality of processing units may be configured to perform different operations on different data. For example, the plurality of processing units can be configured in a multiple-instruction-multiple-data (MIMD) architecture to operate on multiple data using multiple instructions.

The processor 906 can be coupled with the controller interface 912. The controller interface 912 can be implemented in hardware to send and receive signals in a variety of mediums, such as optical, copper, and wireless, and in a number of different protocols some of which may be non-transient.

The controller interface 912 can be coupled with the external controller 914. The external controller 914 can allow a player to interact with the computing device 902. In some embodiments, the external controller 914 can include a game console controller, a mouse, a keyboard, or any other device that can provide communication with the computing device 902. Microphones, controllers, etc. may be connected via a physical wire, e.g., via a USB connection, or may be connected wirelessly, e.g., via Bluetooth, FM, a proprietary wireless protocol used by the Microsoft Xbox One game console, or other wireless signaling protocols.

In some embodiments, the processor 906 can be coupled to a video rendering module 908 and sound piece updating and audio rendering module 910. The video rendering module 908 can be configured to generate a video display based on instructions from processor 906, while the sound piece updating and audio rendering module 910 can be configured to generate sounds accompanying the video display and update a sound piece responsive to synchronization data received by the computing device 902, as described herein. The video rendering module 908 and sound piece updating and audio rendering module 910 can be coupled to an audio/video device 916.

In some embodiments, the one or more audio/video devices 916 can include a display device, e.g., a CRT (cathode ray tube), LCD (liquid crystal display) monitor, or LED (light emitting diode) monitor, a television, an integrated display, e.g., the display of a PLAYSTATION® VITA or Nintendo 3DS, a VR headset, or other type of device capable of displaying video and accompanying audio sounds. While FIG. 9 shows two separate connections into the one or more audio/video devices 916, other embodiments in which the two connections are combined into a single connection are also possible. In some embodiments, one of the audio/video devices 916 can reside in a first system (e.g., a display system) and another one of the audio/video devices 916 can reside in second system (e.g., a sound system).

In some embodiments, one or more of the modules 908, and 910 can be implemented in software using the memory device 904. The software can run on a processor 906 capable of executing computer instructions or computer code. The processor 906 is implemented in hardware using an application specific integrated circuit (ASIC), programmable logic array (PLA), digital signal processor (DSP), field programmable gate array (FPGA), or any other integrated circuit. The processor 906 suitable for the execution of a computer program includes, by way of example, both general and special purpose microprocessors, digital signal processors, and any one or more processors of any kind of digital computer. Generally, the processor 906 receives instructions and data from a read-only memory or a random access memory or both.

In some embodiments, one or more of the modules (e.g., modules 908, 910) can be implemented in hardware using an ASIC (application-specific integrated circuit), PLA (programmable logic array), DSP (digital signal processor), FPGA (field programmable gate array), or other integrated circuit. In some embodiments, two or more modules 908, 910 can be implemented on the same integrated circuit, such as ASIC, PLA, DSP, or FPGA, thereby forming a system on chip. Subroutines can refer to portions of the computer program and/or the processor/special circuitry that implement one or more functions.

The modules 908, 910 can be implemented in digital electronic circuitry, or in computer hardware, firmware, software, or in combinations of them. The implementation can be as a computer program product, e.g., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

While the modules 908, 910 are depicted as separate modules outside of processor 906 (e.g., as stand-alone graphics cards or sound cards), other embodiments are also possible. For example, one or both modules can be implemented as specialized hardware blocks within processor 906. Alternatively, one or more modules 908, 910, can be implemented purely as software running within processor 906.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

Various aspects are described in this disclosure, which include, but are not limited to, the following aspects:

1. A method performed by a system for synchronizing a sound piece across a plurality of devices generating respective audio signals of the sound piece, the method comprising:
using at least one computer processor of the system to perform:
   transmitting, to the plurality of devices, synchronization data indicating:
an audio sequence of the sound piece for rendering, by the plurality of devices, the respective audio signals; and
a target point in the audio sequence for the plurality of devices to use in synchronizing rendering of the respective audio signals;
   receiving, from a first device of the plurality of devices, a first input indicating a modification to the audio sequence of the sound piece;
   in response to receiving the first input, updating the synchronization data to generate updated synchronization data, the updated synchronization data indicating an updated target point in the audio sequence and the modification to the audio sequence;
   transmitting, to one or more of the plurality of devices, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

2. The method of aspect 1, wherein updating the synchronization data to generate the updated synchronization data comprises:
determining a modification to the audio sequence at or after a first point based on the first input indicating the modification to the sound piece corresponding to the first point; and
applying the modification to the audio sequence at or after the first point to obtain an updated audio sequence such that the updated synchronization data indicates the updated audio sequence.

3. The method of aspect 2, wherein determining the modification to the audio sequence at or after the first point in the audio sequence based on the first input indicating the modification to the sound piece comprises:
determining one or more effects to add to the audio sequence at or after the first point in the audio sequence.

4. The method of any of aspects 2-3, wherein the synchronization data indicating the audio sequence comprises a sequence of numerical values representing the audio sequence, and applying the modification to the audio sequence to generate the updated audio sequence comprises:
modifying the sequence of numerical values to obtain an updated sequence of numerical values representing the updated audio sequence.

5. The method of any of aspects 1-4, wherein:
the synchronization data indicating the audio sequence of the sound piece comprises an indication of tempo for outputting the audio sequence;
the modification to the sound piece corresponding to the first point in the audio sequence of the sound piece comprises a modification to the tempo at the first point in the audio sequence;
and updating the synchronization data to generate the updated synchronization data comprises updating the synchronization data to indicate an updated tempo for outputting the audio sequence.

6. The method of any of aspects 1-5, wherein the modification to the sound piece indicated by the user input comprises at least one of:
an addition of one or more notes to the audio sequence at and/or after the first point;
a removal of one or more notes from the audio sequence of the sound piece;
an addition of one or more effects to the audio sequence of the sound piece;
a removal of one or more effects from the audio sequence of the sound piece;
a modification to one or more effects in the audio sequence of the sound piece;
a modification to a key of the sound piece;
a modification to a mode of the sound piece;
a stoppage of rendering the sound piece into an audio signal;
a resuming of rendering the sound piece into an audio signal; or restarting rendering of the sound piece from a beginning of the audio sequence.

7. The method of any of aspects 1-6, wherein causing each of the one or more devices to synchronize rendering of a respective audio signal using the updated target point in the audio sequence comprises causing the device to:
configure a respective speed of rendering the respective audio signal based on the updated target point in the audio sequence.

8. A system for synchronizing a sound piece across a plurality of devices generating respective audio signals of the sound piece, the system comprising:
at least one computer processor; and
at least one non-transitory computer readable medium storing processor-executable instructions, that when executed by the at least one processor, cause the at least one processor to perform:
transmitting, to the plurality of devices, synchronization data indicating:
an audio sequence of the sound piece for rendering, by the plurality of devices, the respective audio signals; and
a target point in the audio sequence for the plurality of devices to use in synchronizing rendering of the respective audio signals;
receiving, from a first device of the plurality of devices, a first input indicating a modification to the audio sequence of the sound piece;
in response to receiving the first input, updating the synchronization data to generate updated synchronization data, the updated synchronization data indicating an updated target point in the audio sequence and the modification to the audio sequence;
transmitting, to one or more of the plurality of devices, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

9. The system of aspect 8, wherein updating the synchronization data to generate the updated synchronization data comprises:
determining a modification to the audio sequence at or after the first point based on the first input indicating the modification to the sound piece corresponding to the first point; and
applying the modification to the audio sequence at or after the first point to obtain an updated audio sequence such that the updated synchronization data indicates the updated audio sequence.

10. The system of aspect 9, wherein determining the modification to the audio sequence at or after the first point in the audio sequence based on the first input indicating the modification to the sound piece comprises:
determining one or more effects to add to the audio sequence at or after the first point in the audio sequence.

11. The system of any of aspects 9-10, wherein the synchronization data indicating the audio sequence comprises a sequence of numerical values representing the audio sequence, and applying the modification to the audio sequence to generate the updated audio sequence comprises:
modifying the sequence of numerical values to obtain an updated sequence of numerical values representing the updated audio sequence.

12. The system of any of aspects 8-11, wherein:
the synchronization data indicating the audio sequence of the sound piece comprises an indication of tempo for outputting the audio sequence;
the modification to the sound piece corresponding to the first point in the audio sequence of the sound piece comprises a modification to the tempo at the first point in the audio sequence; and
updating the synchronization data to generate the updated synchronization data comprises updating the synchronization data to indicate an updated tempo for outputting the audio sequence.

13. The system of any of aspects 8-12, wherein the modification to the sound piece indicated by the user input comprises at least one of:
an addition of one or more notes to the audio sequence at and/or after the first point;
a removal of one or more notes from the audio sequence of the sound piece;
an addition of one or more effects to the audio sequence of the sound piece;
a removal of one or more effects from the audio sequence of the sound piece;
a modification to one or more effects in the audio sequence of the sound piece;
a modification to a key of the sound piece;
a modification to a mode of the sound piece;
a stoppage of rendering the sound piece into an audio signal;
a resuming of rendering the sound piece into an audio signal; or restarting rendering of the sound piece from a beginning of the audio sequence.

14. The system of any of aspects 8-13, wherein causing each of the one or more devices to synchronize rendering of a respective audio signal using the updated target point in the audio sequence comprises causing the device to:
configure a respective speed of rendering the respective audio signal based on the updated target point in the audio sequence.

15. A non-transitory computer-readable medium storing processor-executable instructions, that when executed by at least one computer processor, causes the at least one computer processor to perform a method for synchronizing a sound piece across a plurality of devices generating respective audio signals of the sound piece, the method comprising:
transmitting, to a plurality of devices, synchronization data indicating:
an audio sequence of a sound piece for rendering, by the plurality of devices, respective audio signals; and
a target point in the audio sequence for the plurality of devices to use in synchronizing rendering of the respective audio signals;
receiving, from a first device of the plurality of devices, a first input indicating a modification to the audio sequence of the sound piece;
in response to receiving the first input, updating the synchronization data to generate updated synchronization data, the updated synchronization data indicating an updated target point in the audio sequence and the modification to the audio sequence;
transmitting, to one or more of the plurality of devices separate from the first device, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

16. The non-transitory computer-readable medium of aspect 15, wherein updating the synchronization data to generate the updated synchronization data comprises:
determining a modification to the audio sequence at or after the first point based on the first input indicating the modification to the sound piece corresponding to the first point; and
applying the modification to the audio sequence at or after the first point to obtain an updated audio sequence such that the updated synchronization data indicates the updated audio sequence.

17. The non-transitory computer-readable medium of aspect 16, wherein determining the modification to the audio sequence at or after the first point in the audio sequence based on the first input indicating the modification to the sound piece comprises:
determining one or more effects to add to the audio sequence at or after the first point in the audio sequence.

18. The non-transitory computer-readable storage medium of any of aspects 16-17, wherein the synchronization data indicating the audio sequence comprises a sequence of numerical values representing the audio sequence, and applying the modification to the audio sequence to generate the updated audio sequence comprises:
modifying the sequence of numerical values to obtain an updated sequence of numerical values representing the updated audio sequence.

19. The non-transitory computer-readable storage medium of any of aspects 15-18, wherein:
the synchronization data indicating the audio sequence of the sound piece comprises an indication of tempo for outputting the audio sequence;
the modification to the sound piece corresponding to the first point in the audio sequence of the sound piece comprises a modification to the tempo at the first point in the audio sequence; and
updating the synchronization data to generate the updated synchronization data comprises updating the synchronization data to indicate an updated tempo for outputting the audio sequence.

20. The non-transitory computer-readable storage medium of any of aspects 15-19, wherein causing each of the one or more devices to synchronize rendering of a respective audio signal using the updated target point in the audio sequence comprises causing the device to:
configure a respective speed of rendering the respective audio signal based on the updated target point in the audio sequence.

21. A method for synchronizing a sound piece on a device with a plurality of devices generating respective audio signals of the sound piece, the method comprising:
using at least one computer processor of the device to perform:
receiving, from a synchronization system, synchronization data indicating an audio sequence of the sound piece and a target point in the audio sequence;
rendering an audio signal using the synchronization data;
while rendering the audio signal, receiving updated synchronization data indicating an updated target point and a modification to the audio sequence, the updated synchronization data received after input from another one of the plurality of devices was provided to the synchronization system, the input indicating the modification to the audio sequence; and
in response to receiving the updated synchronization data, rendering the audio signal using the updated synchronization data at least in part by synchronizing the rendering based on the updated target point in the audio sequence.

22. The method of aspect 21, wherein synchronizing the rendering based on the updated target point in the audio sequence comprises configuring the speed of rendering the audio signal using the updated target point.

23. The method of aspect 22, wherein configuring the speed of rendering the audio signal using the updated target point comprises:
determining a difference between a current point in the audio sequence of the device and the updated target point in the audio sequence; and
configuring the speed of rendering the audio signal based on the difference between the current point in the audio sequence of the device and the target point in the audio sequence.

24. The method of aspect 23, wherein configuring the speed of rendering the audio signal based on the difference between the current point in the audio sequence of the device and the target point in the audio sequence comprises:
increasing the speed of the rendering of the sound piece to a first adjusted speed; and
decreasing the speed of the rendering from the first adjusted speed to a second adjusted speed when the difference between the current point in the audio sequence of the device and the target point in the audio sequence is less than a threshold amount of time.

25. The method of any of aspects 22-24, wherein configuring the speed of rendering the audio signal using the updated target point comprises:
determining whether any additional modification to the audio sequence is received within a time period after receiving the modification to the audio sequence;
enabling modification of the speed of rendering the audio signal when it is determined that no additional modification to the audio sequence is received within the time period; and
preventing modification of the speed of rendering the audio signal when it is determined that an additional modification to the audio sequence is received within the time period.

26. The method of any of aspects 21-25, wherein synchronizing the rendering based on the updated target point in the audio sequence comprises:
determining a difference between a current point in the audio sequence of the device and the updated target point in the audio sequence;
when the difference is less than a threshold difference, configuring the speed of rendering the audio signal to decrease the difference between the current point of the device with the updated target point; and
when the difference is greater than the threshold difference, triggering rendering of the audio signal from the updated target point in the audio sequence.

27. The method of any of aspects 21-26, wherein the updated synchronization data indicates stopping rendering of the audio signal or initiating rendering of the audio signal from a beginning of the audio sequence, and rendering the audio signal using the updated synchronization data comprises:
stopping rendering of the audio signal or initiating rendering of the audio signal from the beginning of the audio sequence.

28. The method of any of aspects 21-26, further comprising:
receiving, through a graphical user interface (GUI) presented on a display of the device, a user input indicating another modification to the audio sequence; and
transmitting, to the synchronization system, data indicating the other modification to the audio sequence.

29. The method of aspect 28, wherein the GUI provides an interactive environment of a video game and the user input indicates selection of a graphical element in the interactive environment of the video game that indicates the other modification to the audio sequence.

30. The method of any of aspects 28-29, wherein the other modification to the sound piece indicated by the user input comprises at least one of:
a change in tempo of outputting the audio sequence;
an addition of one or more notes to the audio sequence at and/or after the target point;
a removal of one or more notes from the audio sequence of the sound piece;
an addition of one or more effects to the audio sequence of the sound piece;
a removal of one or more effects from the audio sequence of the sound piece;
a modification to one or more effects in the audio sequence of the sound piece;
a modification to a key of the sound piece;
a modification to a mode of the sound piece;
a stoppage of rendering the sound piece into an audio signal;
a resuming of rendering the sound piece into an audio signal; or
restarting rendering of the sound piece from a beginning of the audio sequence.

31. The method of any of aspects 28-31, further comprising, in response to receiving the user input indicating the other modification to the audio sequence:
applying the other modification to the audio sequence; and
rendering the audio signal using the audio sequence including the other modification.

32. A device configured to synchronize a sound piece with a plurality of devices generating respective audio signals of the sound piece, the device comprising:
at least one computer processor; and
at least one non-transitory computer readable medium storing processor-executable instructions, that when executed by the at least one computer processor, cause the at least one computer processor to perform:
receiving, from a synchronization system, synchronization data indicating an audio sequence of the sound piece and a target point in the audio sequence;
rendering an audio signal using the synchronization data;
while rendering the audio signal, receiving updated synchronization data indicating an updated target point and a modification to the audio sequence, the updated synchronization received after input from another one of the plurality of devices provided to the synchronization system, the input indicating the modification to the audio sequence; and
in response to receiving the updated synchronization data, rendering the audio signal using the updated synchronization data at least in part by synchronizing the rendering based on the updated target point in the audio sequence.

33. The device of aspect 32, wherein synchronizing the rendering based on the updated target point in the audio sequence comprises configuring the speed of rendering the audio signal using the updated target point.

34. The device of aspect 33, wherein configuring the speed of rendering the audio signal using the updated target point comprises:
determining a difference between a current point in the audio sequence of the device and the updated target point in the audio sequence; and
configuring the speed of rendering the audio signal based on the difference between the current point in the audio sequence of the device and the target point in the audio sequence.

35. The device of aspect 34, wherein configuring the speed of rendering the audio signal based on the difference between the current point in the audio sequence of the device and the target point in the audio sequence comprises:
increasing the speed of the rendering of the sound piece to a first adjusted speed; and
decreasing the speed of the rendering from the first adjusted speed to a second adjusted speed when the difference between the current point in the audio sequence of the device and the target point in the audio sequence is less than a threshold amount of time.

36. The device of any of aspects 33-34, wherein configuring the speed of rendering the audio signal using the updated target point comprises:
determining whether any additional modification to the audio sequence is received within a time period after receiving the modification to the audio sequence;
enabling modification of the speed of rendering the audio signal when it is determined that no additional modification to the audio sequence is received within the time period; and
preventing modification of the speed of rendering the audio signal when it is determined that an additional modification to the audio sequence is received within the time period.

37. The device of any of aspects 32-36, wherein synchronizing the rendering based on the updated target point in the audio sequence comprises:
determining a difference between a current point in the audio sequence of the device and the updated target point in the audio sequence;
when the difference is less than a threshold difference, configuring the speed of rendering the audio signal to decrease the difference between the current point of the device with the updated target point; and
when the difference is greater than the threshold difference, triggering rendering of the audio signal from the updated target point in the audio sequence.

38. The device of any of aspects 32-37, wherein the updated synchronization data indicates stopping rendering of the audio signal or initiating rendering of the audio signal from a beginning of the audio sequence, and rendering the audio signal using the updated synchronization data comprises:
stopping rendering of the audio signal or initiating rendering of the audio signal from the beginning of the audio sequence.

39. The device of any of aspects 32-38, wherein the instructions further cause the at least one computer processor to perform:
receiving, through a graphical user interface (GUI) presented on a display of the device, a user input indicating an other modification to the audio sequence; and
transmitting, to the synchronization system, data indicating the other modification to the audio sequence.

40. A non-transitory computer-readable medium storing processor-executable instructions, that when executed by at least one computer processor, cause the at least one computer processor of a device to perform a method for synchronizing a sound piece on the device with a plurality of devices generating respective audio signals of the sound piece, the method comprising:
receiving, from a synchronization system, synchronization data indicating an audio sequence of a sound piece and a target point in the audio sequence;
rendering an audio signal using the synchronization data;
while rendering the audio signal, receiving updated synchronization data indicating an updated target point and a modification to the audio sequence, the updated synchronization received after input from another one of a plurality of devices provided to the synchronization system, the input indicating the modification to the audio sequence; and
in response to receiving the updated synchronization data, rendering the audio signal using the updated synchronization data at least in part by synchronizing the rendering based on the updated target point in the audio sequence.

What is claimed is:

1. A method performed by a system for synchronizing a sound piece across a plurality of devices generating respective audio signals of the sound piece, the method comprising:
using at least one computer processor of the system to perform:
transmitting, to the plurality of devices, synchronization data indicating:
an audio sequence of the sound piece for rendering, by the plurality of devices, the respective audio signals; and
a target point in the audio sequence for the plurality of devices to use in synchronizing rendering of the respective audio signals;
receiving, from a first device of the plurality of devices, a first input indicating a modification to the audio sequence of the sound piece;
in response to receiving the first input, updating the synchronization data to generate updated synchronization data, the updated synchronization data indicating an updated target point in the audio sequence and the modification to the audio sequence;
transmitting, to one or more of the plurality of devices, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

2. The method of claim 1, wherein updating the synchronization data to generate the updated synchronization data comprises:
determining a modification to the audio sequence at or after a first point based on the first input indicating the modification to the sound piece corresponding to the first point; and
applying the modification to the audio sequence at or after the first point to obtain an updated audio sequence such that the updated synchronization data indicates the updated audio sequence.

3. The method of claim 2, wherein determining the modification to the audio sequence at or after the first point in the audio sequence based on the first input indicating the modification to the sound piece comprises:
determining one or more effects to add to the audio sequence at or after the first point in the audio sequence.

4. The method of claim 2, wherein the synchronization data indicating the audio sequence comprises a sequence of numerical values representing the audio sequence, and applying the modification to the audio sequence to generate the updated audio sequence comprises:
modifying the sequence of numerical values to obtain an updated sequence of numerical values representing the updated audio sequence.

5. The method of claim 1, wherein:
the synchronization data indicating the audio sequence of the sound piece comprises an indication of tempo for outputting the audio sequence;
the modification to the sound piece corresponding to the first point in the audio sequence of the sound piece comprises a modification to the tempo at the first point in the audio sequence; and
updating the synchronization data to generate the updated synchronization data comprises updating the synchronization data to indicate an updated tempo for outputting the audio sequence.

6. The method of claim 1, wherein the modification to the sound piece indicated by the user input comprises at least one of:
an addition of one or more notes to the audio sequence at and/or after the first point;
a removal of one or more notes from the audio sequence of the sound piece;
an addition of one or more effects to the audio sequence of the sound piece;
a removal of one or more effects from the audio sequence of the sound piece;
a modification to one or more effects in the audio sequence of the sound piece;
a modification to a key of the sound piece;
a modification to a mode of the sound piece;
a stoppage of rendering the sound piece into an audio signal;
a resuming of rendering the sound piece into an audio signal; or
restarting rendering of the sound piece from a beginning of the audio sequence.

7. The method of claim 1, wherein causing each of the one or more devices to synchronize rendering of a respective audio signal using the updated target point in the audio sequence comprises causing the device to:
configure a respective speed of rendering the respective audio signal based on the updated target point in the audio sequence.

8. A system for synchronizing a sound piece across a plurality of devices generating respective audio signals of the sound piece, the system comprising:
at least one computer processor; and
at least one non-transitory computer readable medium storing processor-executable instructions, that when executed by the at least one processor, cause the at least one processor to perform:
transmitting, to the plurality of devices, synchronization data indicating:
an audio sequence of the sound piece for rendering, by the plurality of devices, the respective audio signals; and
a target point in the audio sequence for the plurality of devices to use in synchronizing rendering of the respective audio signals;
receiving, from a first device of the plurality of devices, a first input indicating a modification to the audio sequence of the sound piece;
in response to receiving the first input, updating the synchronization data to generate updated synchronization data, the updated synchronization data indicating an updated target point in the audio sequence and the modification to the audio sequence;
transmitting, to one or more of the plurality of devices, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

9. The system of claim 8, wherein updating the synchronization data to generate the updated synchronization data comprises:
determining a modification to the audio sequence at or after the first point based on the first input indicating the modification to the sound piece corresponding to the first point; and
applying the modification to the audio sequence at or after the first point to obtain an updated audio sequence such that the updated synchronization data indicates the updated audio sequence.

10. The system of claim 9, wherein determining the modification to the audio sequence at or after the first point in the audio sequence based on the first input indicating the modification to the sound piece comprises:
determining one or more effects to add to the audio sequence at or after the first point in the audio sequence.

11. The system of claim 9, wherein the synchronization data indicating the audio sequence comprises a sequence of numerical values representing the audio sequence, and applying the modification to the audio sequence to generate the updated audio sequence comprises:
modifying the sequence of numerical values to obtain an updated sequence of numerical values representing the updated audio sequence.

12. The system of claim 8, wherein:
the synchronization data indicating the audio sequence of the sound piece comprises an indication of tempo for outputting the audio sequence;
the modification to the sound piece corresponding to the first point in the audio sequence of the sound piece comprises a modification to the tempo at the first point in the audio sequence; and
updating the synchronization data to generate the updated synchronization data comprises updating the synchronization data to indicate an updated tempo for outputting the audio sequence.

13. The system of claim 8, wherein the modification to the sound piece indicated by the user input comprises at least one of:
an addition of one or more notes to the audio sequence at and/or after the first point;
a removal of one or more notes from the audio sequence of the sound piece;
an addition of one or more effects to the audio sequence of the sound piece;
a removal of one or more effects from the audio sequence of the sound piece;
a modification to one or more effects in the audio sequence of the sound piece;
a modification to a key of the sound piece;
a modification to a mode of the sound piece;
a stoppage of rendering the sound piece into an audio signal;
a resuming of rendering the sound piece into an audio signal; or
restarting rendering of the sound piece from a beginning of the audio sequence.

14. The system of claim 8, wherein causing each of the one or more devices to synchronize rendering of a respective audio signal using the updated target point in the audio sequence comprises causing the device to:
configure a respective speed of rendering the respective audio signal based on the updated target point in the audio sequence.

15. A non-transitory computer-readable medium storing processor-executable instructions, that when executed by at least one computer processor, causes the at least one computer processor to perform a method for synchronizing a sound piece across a plurality of devices generating respective audio signals of the sound piece, the method comprising:
transmitting, to a plurality of devices, synchronization data indicating:
an audio sequence of a sound piece for rendering, by the plurality of devices, respective audio signals; and
a target point in the audio sequence for the plurality of devices to use in synchronizing rendering of the respective audio signals;
receiving, from a first device of the plurality of devices, a first input indicating a modification to the audio sequence of the sound piece;
in response to receiving the first input, updating the synchronization data to generate updated synchronization data, the updated synchronization data indicating an updated target point in the audio sequence and the modification to the audio sequence;
transmitting, to one or more of the plurality of devices separate from the first device, the updated synchronization data, wherein transmitting the updated synchronization data causes each of the one or more devices to render a respective audio signal using the updated synchronization data at least in part by synchronizing the rendering of the respective audio signal based on the updated target point in the audio sequence.

16. The non-transitory computer-readable medium of claim 15, wherein updating the synchronization data to generate the updated synchronization data comprises:
determining a modification to the audio sequence at or after the first point based on the first input indicating the modification to the sound piece corresponding to the first point; and
applying the modification to the audio sequence at or after the first point to obtain an updated audio sequence such that the updated synchronization data indicates the updated audio sequence.

17. The non-transitory computer-readable medium of claim 16, wherein determining the modification to the audio sequence at or after the first point in the audio sequence based on the first input indicating the modification to the sound piece comprises:
determining one or more effects to add to the audio sequence at or after the first point in the audio sequence.

18. The non-transitory computer-readable storage medium of claim 16, wherein the synchronization data indicating the audio sequence comprises a sequence of numerical values representing the audio sequence, and applying the modification to the audio sequence to generate the updated audio sequence comprises:
modifying the sequence of numerical values to obtain an updated sequence of numerical values representing the updated audio sequence.

19. The non-transitory computer-readable storage medium of claim 15, wherein:
the synchronization data indicating the audio sequence of the sound piece comprises an indication of tempo for outputting the audio sequence;
the modification to the sound piece corresponding to the first point in the audio sequence of the sound piece comprises a modification to the tempo at the first point in the audio sequence; and
updating the synchronization data to generate the updated synchronization data comprises updating the synchronization data to indicate an updated tempo for outputting the audio sequence.

20. The non-transitory computer-readable storage medium of claim 15, wherein causing each of the one or more devices to synchronize rendering of a respective audio signal using the updated target point in the audio sequence comprises causing the device to:
configure a respective speed of rendering the respective audio signal based on the updated target point in the audio sequence.
